(19) United States
(12) Patent Application Publication
(10) Pub. No.: US 2024/0354882 A1
(43) Pub. Date: Oct. 24, 2024

(54) Employment and/or Income Verification System and Methods

(71) Applicant: VerificationProfessional, LLC, Wrightsville Beach, NC (US)

(72) Inventor: Shawn Shahriar Nasseri, Wrightsville Beach, NC (US)

(73) Assignee: VerificationProfessional, LLC, Wrightsville Beach, NC (US)

(21) Appl. No.: 18/637,819

(22) Filed: Apr. 17, 2024

Related U.S. Application Data
(60) Provisional application No. 63/460,087, filed on Apr. 18, 2023.
(60) Provisional application No. 63/534,256, filed on Aug. 23, 2023.

(51) Int. Cl. G06Q 50/26; G06Q 10/1053; G06Q 40/03

(52) U.S. Cl. CPC G06Q 50/265; G06Q 10/1053; G06Q 40/03

(57) ABSTRACT

An employment, income, and/or unemployment claims and/or benefits verification system and method. The system may include a server, the server may include a verification application, a controller, operating memory, and a communications interface, wherein the server is accessible via a network; a data store in communication with the server; one or more data sources, wherein the one or more data sources may be accessible to the verification application via the network; and wherein the controller may be configured to execute stored program instructions. The stored program instructions may include providing access to a user of the verification system; receiving a submission for a verification request of employment, income, and/or unemployment claims and/or benefits of a person; processing the verification request; and automatically sending a notification to the person that is the subject of the verification request that the verification request has been requested

### RELATED APPLICATIONS

This application is related and claims priority to U.S. Provisional Patent Application Nos.: 63/460,087, filed on Apr. 18, 2023 and 63/534,256, filed on Aug. 23, 2023, the applications of which are incorporate herein by reference in their entirety.

### TECHNICAL FIELD

The subject matter of the invention relates generally to information verification systems and more particularly to an employment and/or income verification system and methods including information control and notifications.

### SUMMARY

In one embodiment, a verification system is provided. The verification system may include a server, the server may include a verification application, a controller, operating memory, and a communications interface, wherein the server is accessible via a network; a data store in communication with the server; one or more data sources, wherein the one or more data sources may be accessible to the verification application via the network; and wherein the controller may be configured to execute stored program instructions. The stored program instructions may include providing access to a user of the verification system; receiving a submission for a verification request by a verifier; processing the verification request; and automatically sending a notification to a verifyee that is the subject of the verification request that the verification request has been requested. The verification system is for verifying one or more of employment, income, and/or unemployment claims and/or benefits of the verifyee. The receiving a submission for a verification request may include receiving a permitted purpose for the verification request and receiving identifying information related to the verifyee. The identifying information related to the verifyee may include a temporary PIN. The temporary PIN may be set by the verifyee and may be set to have a defined expiration date. The controller may be configured to execute stored program instructions that may further include, upon processing the verification request, automatically generating a verification report about the verifyee. The verification report may include information related to one or more of employment, income, and/or unemployment claims and/or benefits of the verifyee. The notification may include a text messaging and/or a pop-up notification. The data store may include employer records, wherein the employer records may include employee data.

In another embodiment, a method of using a verification system is provided. The method may include, providing a verification system. The verification system may include a server, the server may include a verification application, a controller, operating memory, and a communications interface, wherein the server may be accessible via a network; a data store in communication with the server; one or more data sources, wherein the one or more data sources may be accessible to the verification application via the network; and wherein the controller may be configured to execute stored program instructions. The stored program instructions may include, providing access to a user of the verification system; receiving a submission for a verification request by a verifier; processing the verification request; automatically generating a verification report about a verifyce that is the subject of the verification request; and automatically sending a notification to the verifyee that the verification request has been requested. The method may further include accessing the verification application; selecting the permitted purpose for submitting the verification request; inputting identifying information related to the verifyce; submitting the verification request; and receiving a verification report about the verifyee. The verification system may be for verifying one or more of employment, income, and/or unemployment claims and/or benefits of the verifyee. The receiving a submission for a verification request, may include receiving a permitted purpose for the verification request and receiving identifying information related to the verifyee. The identifying information related to the verifyee may include a temporary PIN. The temporary PIN may be set by the verifyce and may have a set defined expiration date. The verification report may include information related to one or more of employment, income, and/or unemployment claims and/or benefits of the verifyee. The data store may include employer records, wherein the employer records may include employee data. The method may further include automatically sending a notification to the verifyee that the verification request has been requested. The notification may be a text message and/or a pop-up notification.

In yet another embodiment, a verification system is provided. The verification system may include a server, the server may include a verification application, a controller, operating memory, and a communications interface, wherein the server is accessible via a network; a data store in communication with the server; one or more data sources, wherein the one or more data sources may be accessible to the verification application via the network; and wherein the controller may be configured to execute stored program instructions. The stored program instructions may include providing access to a verifyee user of the verification system; receiving and storing verifyee user information; and enabling one or more types of verifications allowable for a verification request. The verifyce user information may include a master PIN and a temporary PIN. The temporary PIN may be set by the verifyee user and may have a set defined expiration date. The master PIN may be assigned by a past or present employer of the verifyce user. The verification system may be for verifying one or more of employment, income, and/or unemployment claims and/or benefits of the verifyee user. The controller may be configured to execute stored program instructions, that further may include, upon the verifyce user setting or updating the Temporary PIN, automatically generating and sending a notification to the verifyee user that the a temporary PIN event has occurred. The controller may be configured to execute stored program instructions, that further may include, upon a verification request being submitted regarding the verifyee user, automatically generating and sending a notification to the verifyee user that a verification event has occurred. The notification may include a text message and/or a pop-up notification. The data store may include employer records, wherein the employer records may include employee data.

In still yet another embodiment, a method of using a verification system is provided. The method may include, providing a verification system. The verification system may include a server, the server may include a verification application, a controller, operating memory, and a communications interface, wherein the server may be accessible via a network; a data store in communication with the server; one or more data sources, wherein the one or more data sources are accessible to the verification application via the network; and wherein the controller is configured to execute stored program instructions. The stored program instructions may include providing access to a verifyee user of the verification system; receiving and storing verifyee user information; and enabling one or more types of verifications allowable for a verification request. The method may further include accessing the verification application; inputting verifyee user information, including a temporary PIN, wherein the temporary PIN is set by the verifyee user and has a defined expiration date; enabling one or more types of verifications allowable for a verification request; and providing the temporary PIN to a verifier. The verifyee user information may include a master PIN, wherein the master PIN may be assigned by a past or present employer of the verifyee user. The verification system may be for verifying one or more of employment, income, and/or unemployment claims and/or benefits of the verifyee user. The controller may be configured to execute stored program instructions, that may further include, upon the verifyee user setting or updating the temporary PIN, automatically generating and sending a notification to the verifyee user that a temporary PIN event has occurred. The controller may be configured to execute stored program instructions, that may further include, upon a verification request being submitted regarding the verifyee user, automatically generating and sending a notification to the verifyee user that a verification event has occurred. The notification may include a text message and/or a pop-up notification.

### BACKGROUND

Today, certain entities, such as, but not limited to, creditors, collection agencies, insurance companies, mortgage companies, loan companies, rental agencies, and banks, may make use of employment and income verification services. Commonly known as verification of employment (VOE) which may also include unemployment claims and/or benefits, and verification of income (VOI) services. For example, when applying for an auto loan or a mortgage, part of the process is verifying the employment and/or income of the applicant. In this example, the loan or mortgage company requests employment and income information from the applicant's employer.

However, in current VOE and VOI processes the persons being verified have no idea that they have been verified and have no idea who has looked at their employment and/or income information. Further, because the person being verified has no idea when or who has sought out their information, the VOE/VOI environment is prone to identity theft.

Further, with respect to unemployment claims, there is from about 80% to about 90% fraudulent claims happening in some states. Unfortunately, the mechanisms for detecting and preventing fraud in the unemployment benefits system are limited.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a block diagram of an example VOE/VOI system including verifyee information control and verifyee notifications, in accordance with an embodiment of the disclosure;

FIG. 2 shows a screenshot of an example home screen of a web portal of the VOE/VOI system shown in FIG. 1, in accordance with an embodiment of the disclosure;

FIG. 3 through FIG. 7 show screenshots of an example verifier login/account creation process using the web portal of the VOE/VOI system shown in FIG. 1, in accordance with an embodiment of the invention;

FIG. 8 through FIG. 22 show screenshots of an example verifyee PIN setup process using the web portal of the VOE/VOI system shown in FIG. 1, in accordance with an embodiment of the invention;

FIG. 23 shows a screenshot of an example PIN setup screen of a mobile app of the VOE/VOI system shown in FIG. 1, in accordance with an embodiment of the invention;

FIG. 24 through FIG. 31 show screenshots of an example verification request process using the web portal of the VOE/VOI system shown in FIG. 1, in accordance with an embodiment of the invention;

FIG. 32 through FIG. 36 show screenshots of an example verification report using the web portal of the VOE/VOI system shown in FIG. 1, in accordance with an embodiment of the invention;

FIG. 37 shows a screenshot of an example of text messages received by a person being verified using the VOE/VOI system shown in FIG. 1, in accordance with an embodiment of the invention;

FIG. 38 through FIG. 43 show more screenshots of an example mobile app of the VOE/VOI system shown in FIG. 1, in accordance with an embodiment of the invention;

FIG. 44 illustrates a flow diagram of an example method of a verifyee using the VOE/VOI system shown in FIG. 1, in accordance with an embodiment of the invention;

FIG. 45 illustrates a flow diagram of an example method of a verifier using the VOE/VOI system shown in FIG. 1, in accordance with an embodiment of the invention;

FIG. 46 illustrates a block diagram of an example of a VOE/VOI system including verifyee information control and verifyee notifications with respect to verifying unemployment claims and/or benefits, in accordance with an embodiment of the disclosure;

FIG. 47 shows a screenshot of an example home screen of a web portal of the VOE/VOI system shown in FIG. 46, in accordance with an embodiment of the disclosure;

FIG. 48 shows a screenshot of an example PIN setup screen of a mobile app of the VOE/VOI system shown in FIG. 46, in accordance with an embodiment of the invention;

FIG. 49 shows a screenshot of an example of text messages received by a person being verified using the VOE/VOI system shown in FIG. 46, in accordance with an embodiment of the invention; and

FIG. 50 illustrates a flow diagram of an example method of a verifier using the VOE/VOI system shown in FIG. 46 with respect to notifications about unemployment claims and/or benefits, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides an employment and/or income verification system and methods including employee/verifyce information control and employee/verifyee notifications. The employment and/or income verification system may be hereafter called a VOE/VOI system. Accordingly, the subject matter of the invention provides a VOE/VOI system and methods including employee information control and employee notifications.

In some embodiments, the VOE/VOI system and methods provide a verification professional application and a data store running on an application server that supports a verification professional web portal.

In some embodiments, the VOE/VOI system and methods provide a verification professional application and a data store running on an application server that supports a verification professional mobile app running on any mobile device.

In some embodiments, the VOE/VOI system and methods provide a verification professional application and a data store running on an application server that supports a personal identification number (PIN)-based verification process that uses both a master PIN of the person being verified that is not shared and a temporary PIN of the person being verified that may be shared for a limited amount of time with a certain verifier.

In some embodiments, the VOE/VOI system and methods provide mechanisms for employee/verifyce information control and employee/verifyce notifications and wherein the employee is one example of the person whose employment and/or income is being verified. The person whose employment and/or income is being verified is referred to herein interchangeable as verifyce or employee.

In some embodiments, the VOE/VOI system and methods provide mechanisms for employee/verifyee information control, such as the capability for the employee/verifyee to select whether employment and/or income may be verified using the verification professional web portal and/or mobile app.

In some embodiments, the VOE/VOI system and methods provide mechanisms for employee notifications, such as the capability for the employee/verifyee to provide a mobile phone number and enable automatic text messaging and/or pop-up notifications using the verification professional web portal and/or mobile app.

In some embodiments, the VOE/VOI system and methods provide mechanisms for employee/verifyee notifications and wherein these notifications may include, for example, an automatic notification of a PIN update, an automatic notification of a verification event, and the like.

In some embodiments, the VOE/VOI system and methods provide mechanisms for employee/verifyee notifications and wherein these automatic notifications may provide a security benefit, such as notification by text message of a PIN update that may be unauthorized.

In some embodiments, the VOE/VOI system and methods provide mechanisms for employee/verifyee information control and employee/verifyee notifications and wherein the employee/verifyee information and/or notifications may be about VOE, VOI, and/or verification of unemployment claims and/or benefits.

In some embodiments, the VOE/VOI system and methods provide mechanisms for employee/verifyee information control and employee/verifyee notifications and wherein the employee/verifyee being verified may be an unemployed individual and wherein the VOE/VOI system and methods may be used for verification of unemployment claims and/or benefits.

In some embodiments, the VOE/VOI system and methods provide mechanisms for helping to detect and prevent fraud in the unemployment benefits system.

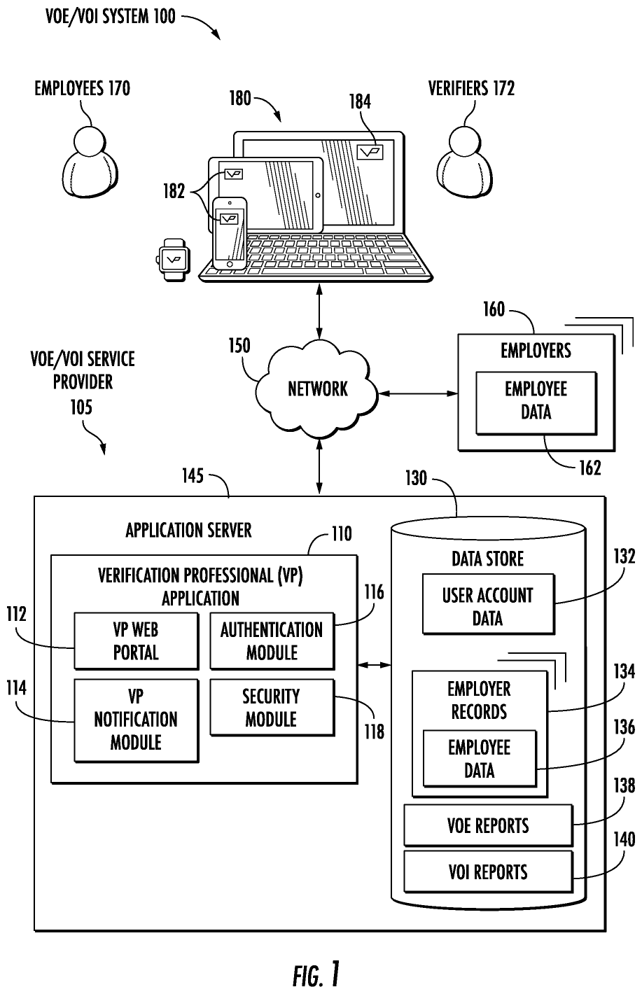

Referring now to FIG. 1 is a block diagram of an example of a VOE/VOI system 100 including employee/verifyee information control and employee/verifyee notifications, in accordance with an embodiment of the disclosure. In this example, VOE/VOI system 100 may be provided in a networked computing configuration that includes a verification professional (VP) application 110 and a data store 130 running on an application server 145.

Certain entities may be associated with VOE/VOI system 100. For example, in VOE/VOI system 100, a VOE/VOI service provider 105 may be the owner/operator/manager of VP application 110 and data store 130 running at application server 145. That is, VOE/VOI service provider 105 may be a third-party contracted by companies or employers to perform VOE/VOI services. VOE/VOI system 100 may include, for example, employers 160. Each employer 160 may provide to VOE/VOI service provider 105 its unique and secure employee data 162. The employer records 134, including employee data 162, may be automatically accessed and/or imported into the data store 130 by the VP application 110 via the network 150. Further, in VOE/VOI system 100, employees 170 may be the persons who are the subject of the VOE/VOI requeststhe “verifyees”, which may also include any other persons who are the subject of the VOE/VOI requests. Further, in VOE/VOI system 100, verifiers 172 may be the entities seeking the VOE/VOI information. Examples of verifiers 172 may include, but are not limited to, creditors, collection agencies, insurance companies, mortgage companies, loan companies, rental agencies, and banks.

At application server 145, VP application 110 may include a VP web portal 112, a VP notification module 114, an authentication module 116, and a security module 118. Further, VP application 110 may support a VP mobile app 182. Further, user account data 132, employer records 134 with each including employee data 136, VOE reports 138, and VOI reports 140 may be stored at data store 130. Additionally, application server 145 may be accessible via a network 150. Network 150 may be, for example, a local area network (LAN) and/or a wide area network (WAN) for connecting to the Internet or to an Intranet. Further, network 150 may be a cellular internet connection. Application server 145 may connect to network 150 by any wired and/or wireless means.

Employees 170 and/or verifiers 172 may access VP application 110 at application server 145 via their respective user computers 180 and network 150. User computers 180 may be any computing device, such as, but not limited to, a desktop computer, a laptop computer, a handheld computing device, a mobile phone (or smart phone), a tablet device, a smartwatch, and the like. Any information about employers 160, employees 170, and verifiers 172 may be stored in user account data 132 at data store 130 of application server 145. For example, a user profile for each employer 160, employee 170, and verifier 172 may be stored in user account data 132. User account data 132 may include, for example, account information, user name, user group name, user/group credentials, user payment information, and the like.

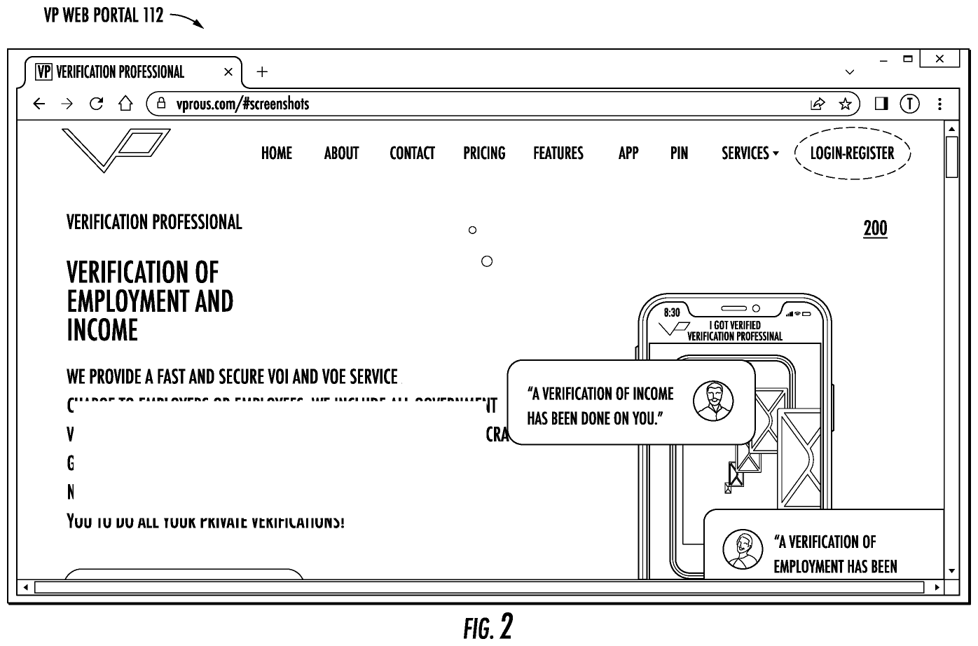

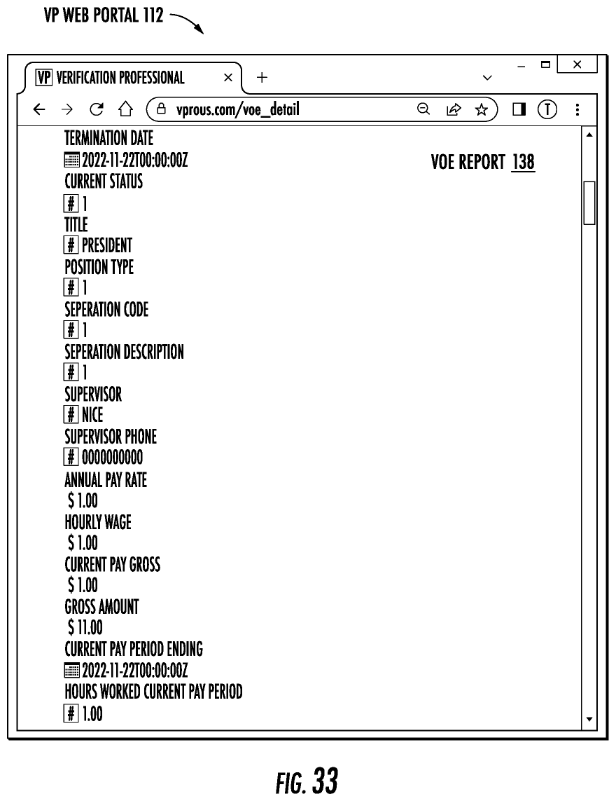

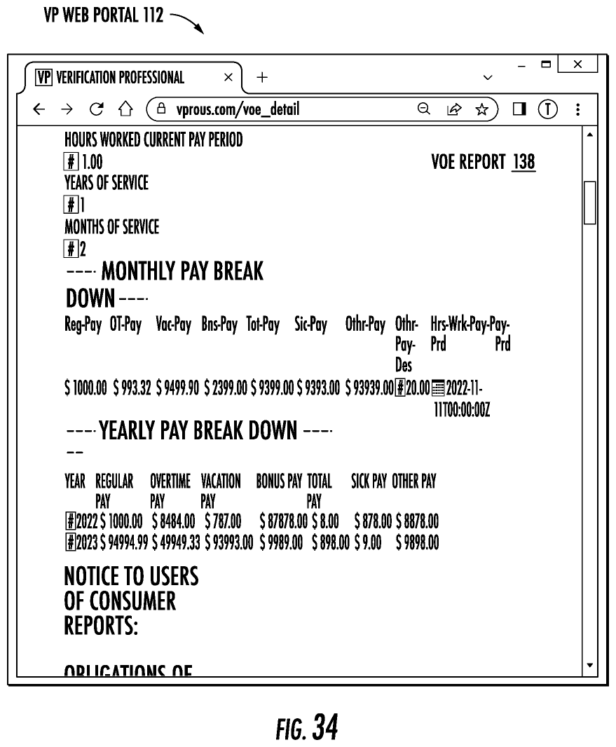

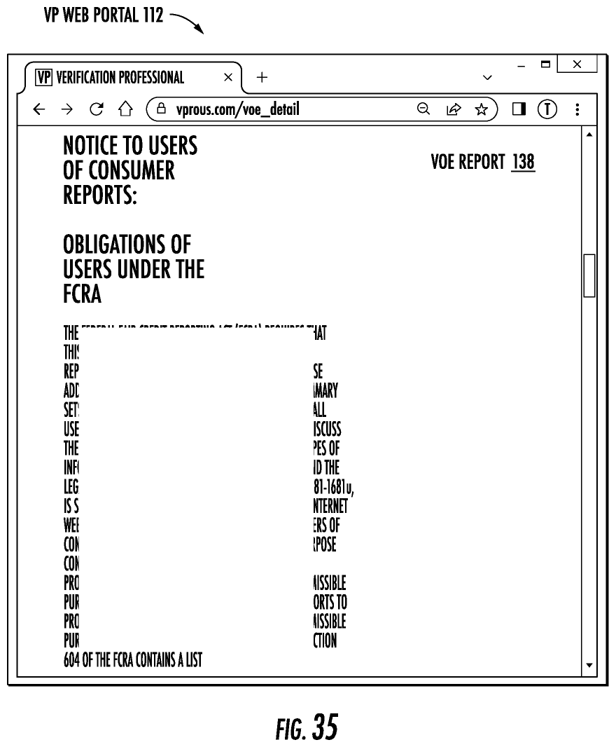

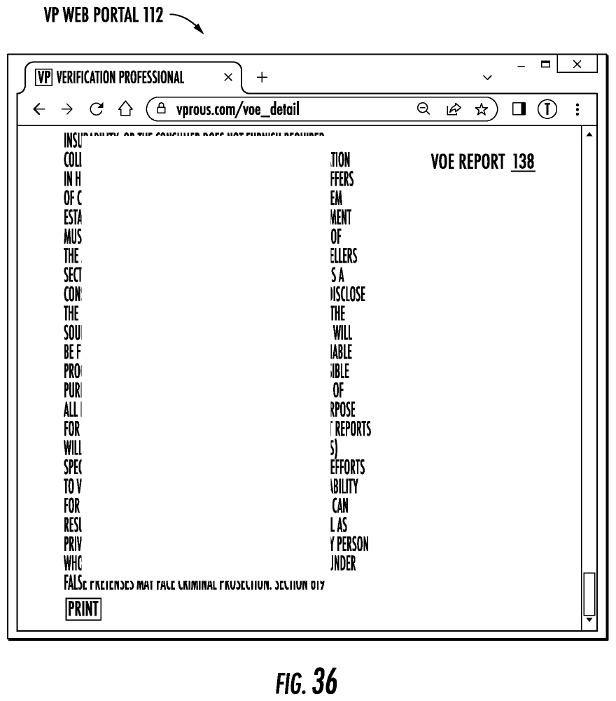

In one example, employees 170 and/or verifiers 172 may interact with the VP application 110 using VP web portal 112 at application server 145. In this example, VP web portal 112 may be a web-based user interface (UI) that is accessible via network 150. For example, VP application 110 at application server 145 may be a software application that may be implemented as a web application and run in a web browser, such as Google Chrome or Microsoft Edge. More details of an example of VP web portal 112 are shown and described below in FIG. 2 through FIG. 36.

A VP desktop application 184 or VP mobile app 182 may be installed and running on each of the user computers 180. VP desktop application 184 and/or VP mobile app 182 may be implemented, for example, as a web application (i.e., React/Node), a desktop application, a mobile app, an application program interface (API), and the like. When configured as a mobile app, VP mobile app 182 may be designed to operate on any device platform, including for example, Windows, Android, Apple, and the like. Accordingly, employees 170 and/or verifiers 172 may interact with the VP application 110 using VP mobile app 182 of their user computer 180 (e.g., smart phone or tablet device).

VOE/VOI system 100 may operate in a client/server computing architecture, which is well known. In this example, VP application 110 at the application server 145 may be the server component of VOE/VOI system 100, while VP mobile app 182 at each of the user computers 180 may be the client component of VOE/VOI system 100. In other words, VP mobile app 182 at each of the user computers 180 may be the counterpart to VP application 110 at application server 145.

Additionally, application server 145 may be any networked computing configuration as long as it is accessible via network 150 by other entities of VOE/VOI system 100. For example, VOE/VOI system 100, and more particularly the VP application 110 on application server 145, may support a cloud computing environment. In a cloud computing environment, application server 145 may be the cloud server. Further, VP application 110 is not limited to running on one application server 145 only. VOE/VOI system 100 may include multiple application servers 145 (or cloud servers) in order to ensure high-availability of computing resources.

Referring still to FIG. 1, VP notification module 114 may be a software module used to manage any notification processes of VP application 110. In one example, VP notification module 114 may be used to manage text messages that may be automatically generated and sent to employees 170 and/or verifiers 172. In another example, VP notification module 114 may be used to manage pop-up notifications that may be automatically generated through VP mobile app 182 and/or VP desktop application 184. Further, other types of notifications are possible, such as email notifications and recorded phone calls.

Authentication module 116 of VP application 110 may be used to manage the authentication process of any entities of VOE/VOI system 100, such as employees 170 and/or verifiers 172. For example, when the verifier 172 signs into the VP application 110, a standard authentication process may be performed that allows the verifier 172 to access VP application 110. User-sign in may occur a number of ways. In one example, employees 170 and/or verifiers 172 may use a web browser to access VP web portal 112 of VP application 110 and enter credentials (e.g., username and password).

In another example, employees 170 and/or verifiers 172 may use VP mobile app 182 of their user computer 180 to enter his/her credentials. In yet another example, the user sign-in process may occur automatically when an employee 170 or verifier 172 starts VP mobile app 182. As employees 170 and/or verifiers 172 are authorized to access VOE/VOI system 100, user information may be stored in user account data 132 in data store 130.

Security module 118 of VP application 110 may be used to perform any system security functions with respect to keeping secure the contents of data store 130 and/or any other information with respect to VOE/VOI system 100. Security module 118 may use standard security techniques, such as encryption, secure hashtags (or hash tags), and the like. Data store 130 may be, for example, data repositories (like databases) and/or flat files that can store data. Further, VOE/VOI system 100 is not limited to one data store 130 only. VOE/VOI system 100 may include multiple data stores 130. Further, data store 130 may be provided on a data server that is separate from application server 145.

Generally, and referring still to FIG. 1, VP application 110 may be a software application that provides a means of processing information in real time and then pushing information to employees 170 and/or verifiers 172 with respect to VOE/VOI operations. VP mobile app 182 provides the means for employees 170 and/or verifiers 172 to interact with VP application 110. For example, using VP mobile app 182, push notifications may be automatically generated to employees 170 and/or verifiers 172 and confirmation notifications may be returned from employees 170 and/or verifiers 172 to VP application 110.

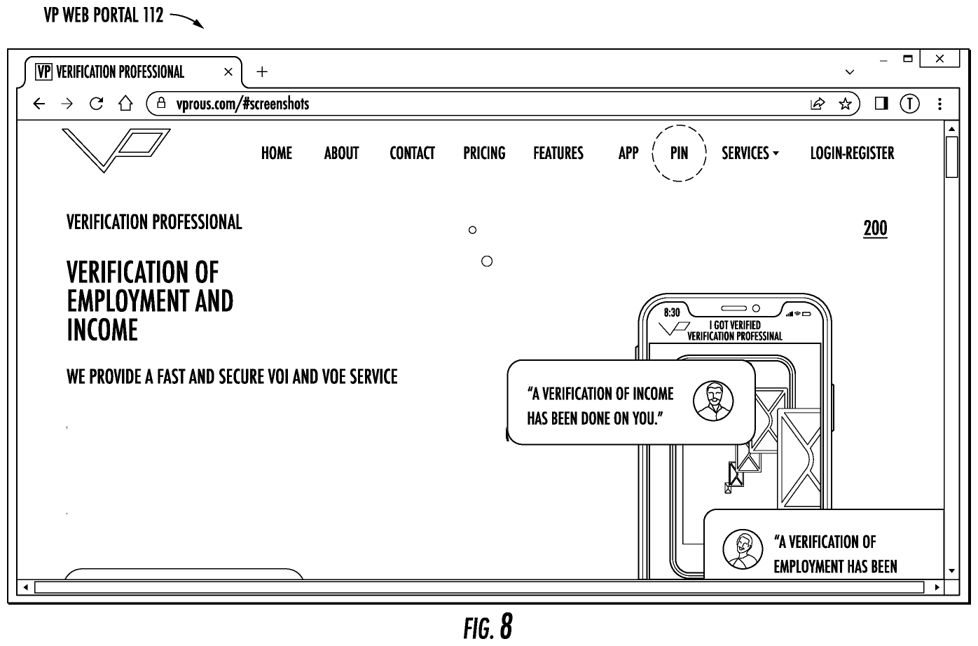

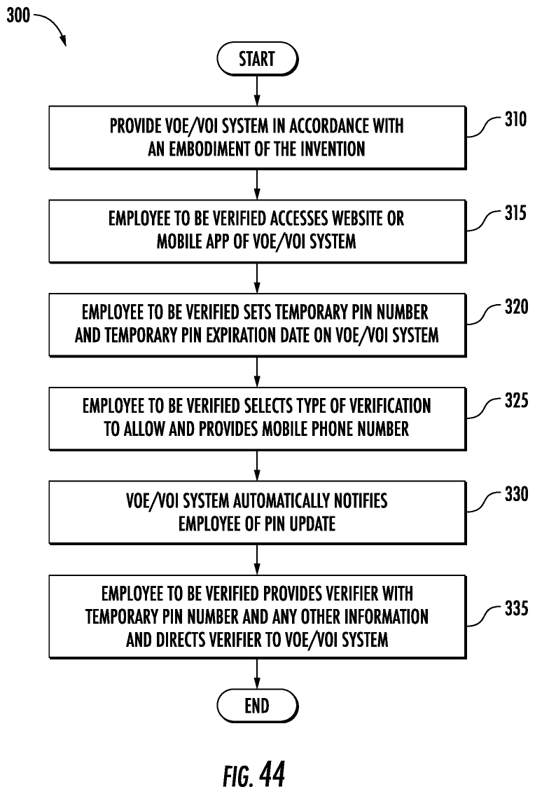

Generally, the PIN-based operation of VP application 110 of VOE/VOI system 100 may be as follows. An employee 170, which is the person to be verified for employment and/or income, may access VP application 110 using VP web portal 112 or VP mobile app 182. The employee 170 may enter information, such as his/her name, company number of employer 160, social security number, a master PIN, a temporary PIN, a temporary PIN expiration date, and a mobile phone number. The employee 170 also enables the type of verification to be allowed, such as VOE, VOI, or both. Upon submitting this information, VP application 110 automatically generates and sends a text message to the employee 170 indicating that a PIN update event has occurred. More details of an example of the pin setup process using VP web portal 112 are shown and described below in FIG. 8 through FIG. 22. Further, more details of an example of an employee 170 using VOE/VOI system 100 is shown and described below in FIG. 44.

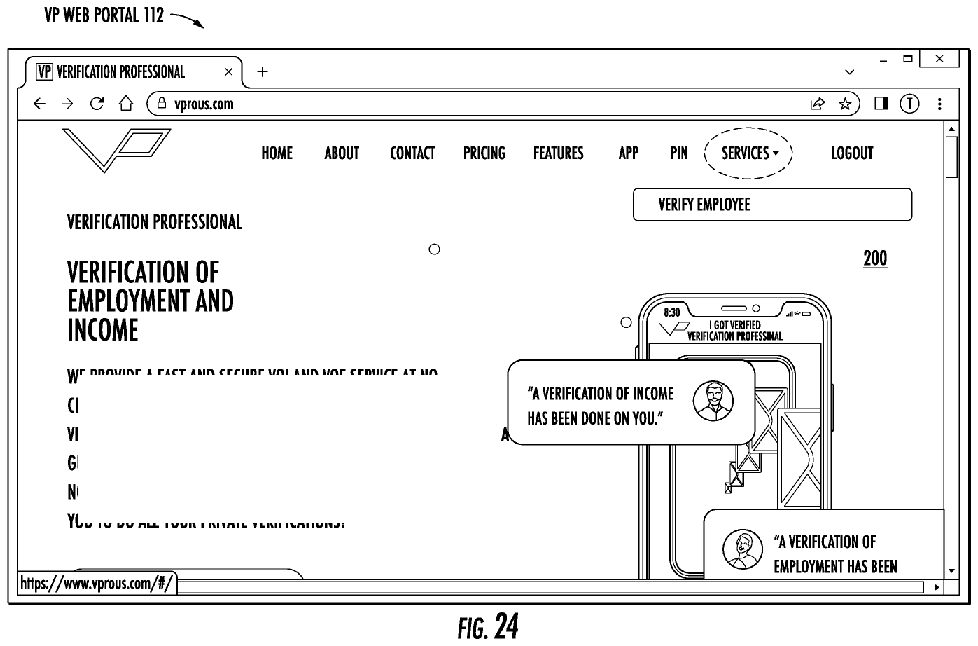

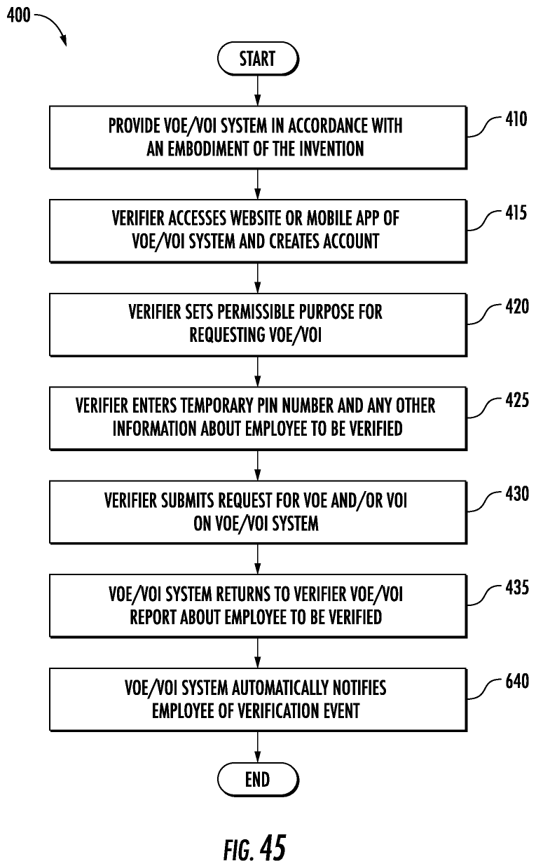

After generating the temporary PIN, the employee 170 may provide the temporary PIN to the verifier 172. The verifier 172 may then use this temporary PIN along with other information about the employee 170 to perform the VOE and/or VOI event. Once the VOE and/or VOI is requested, the verifier 172 receives the VOE/VOI report. Further, VP application 110 automatically generates and sends a text message to the employee 170 indicating that a VOE/VOI event has occurred. More details of an example of the verification request process using VP web portal 112 are shown and described below in FIG. 24 through FIG. 36. Further, more details of an example of a verifier 172 using VOE/VOI system 100 is shown and described below in FIG. 45.

In the example verification request process described above, the employee 170 is expecting the two text messages: one indicating the PIN update event and another indicating the VOE/VOI event. That is, the PIN update event text message is a result of employee 170 action, while the VOE/VOI event text message is a result of verifier 172 action.

Accordingly, if the employee 170 receives any additional or unexpected text message notifications from VOE/VOI system 100, this may be an indication of unauthorized activity. That is, the automatic PIN-based notifications of VP application 110 may provide a security benefit by indicating to the employee 170 the possibility of unauthorized use (e.g., due to identity theft). In this case, the automatic notifications may serve as a warning that prompts the employee 170 to change his/her master PIN and/or temporary PIN and therefore block any further unauthorized access to his/her employment and/or income information.

Referring now to FIG. 2 is a screenshot of an example of a home screen 200 of VP web portal 112 of VOE/VOI system 100 shown in FIG. 1, in accordance with an embodiment of the disclosure. Home screen 200 may include various control or navigation buttons. For example, but not limited to, a Home button, an About button, a Contact button, a Pricing button, a Features button, an App button, a PIN button, a Services button, and a Login-Register button.

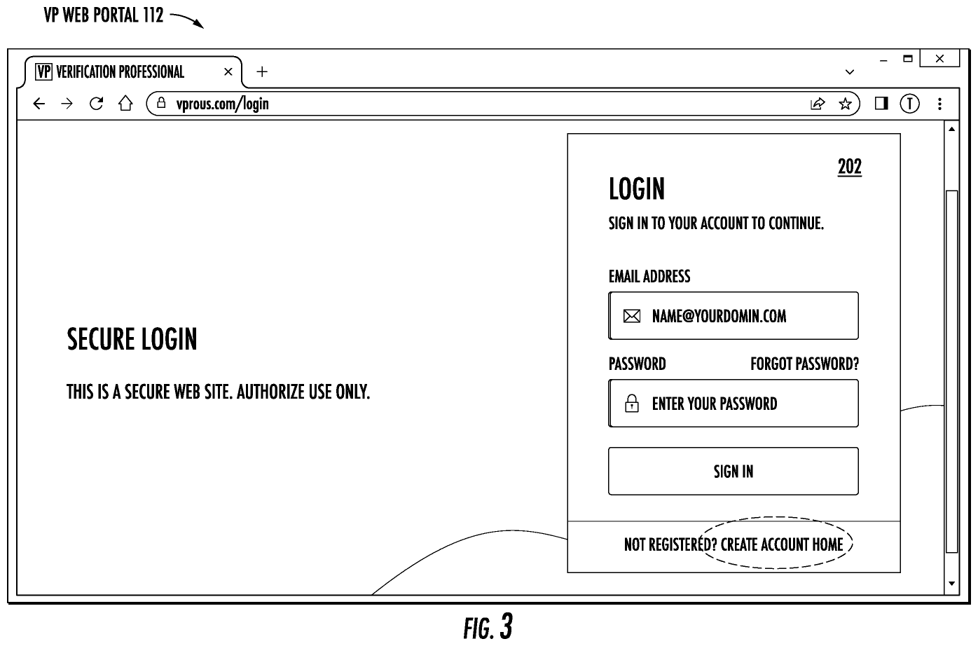

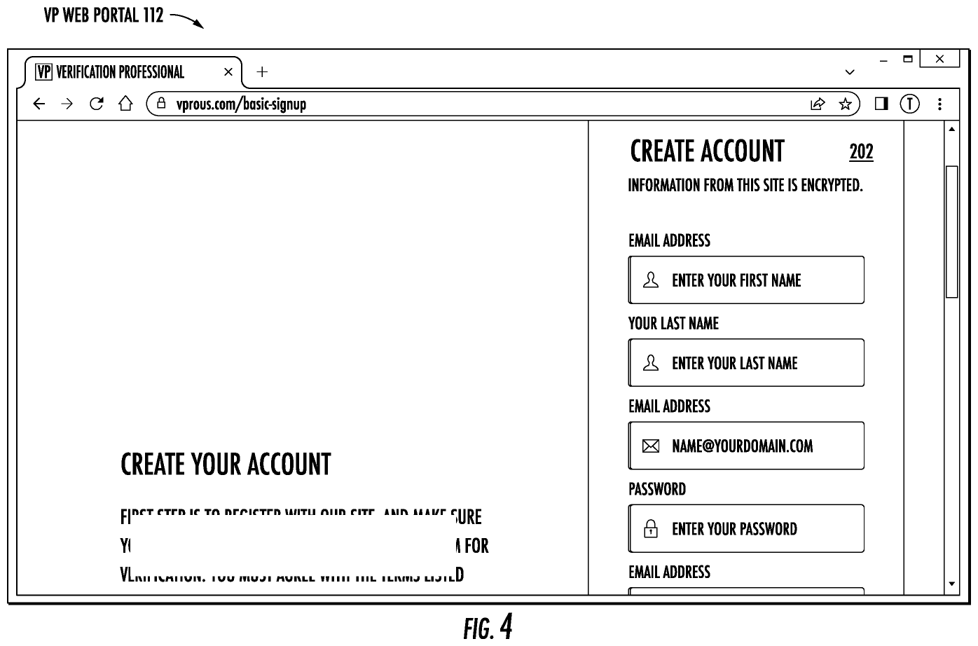

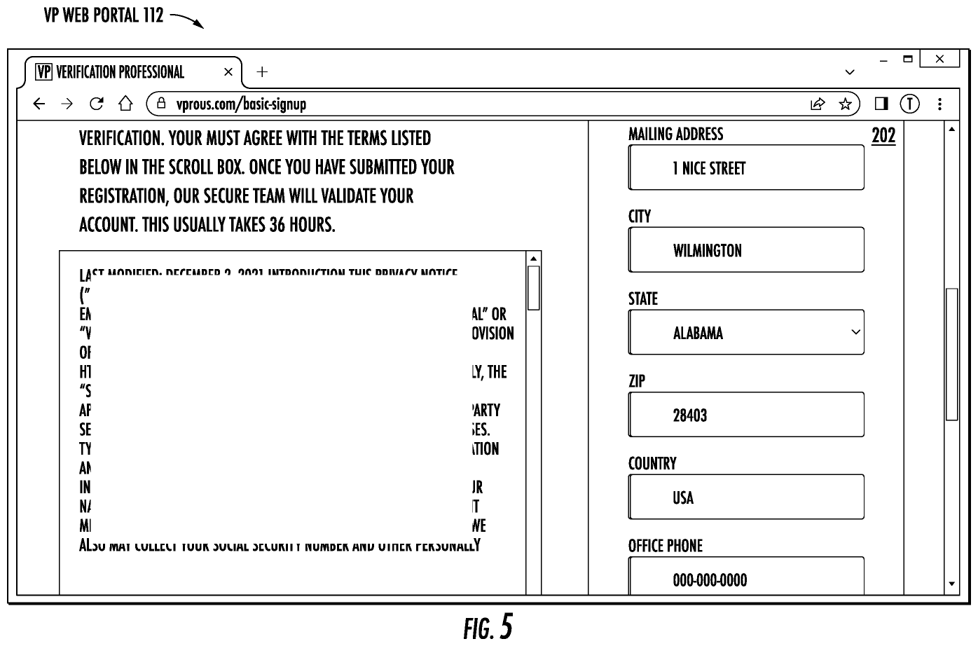

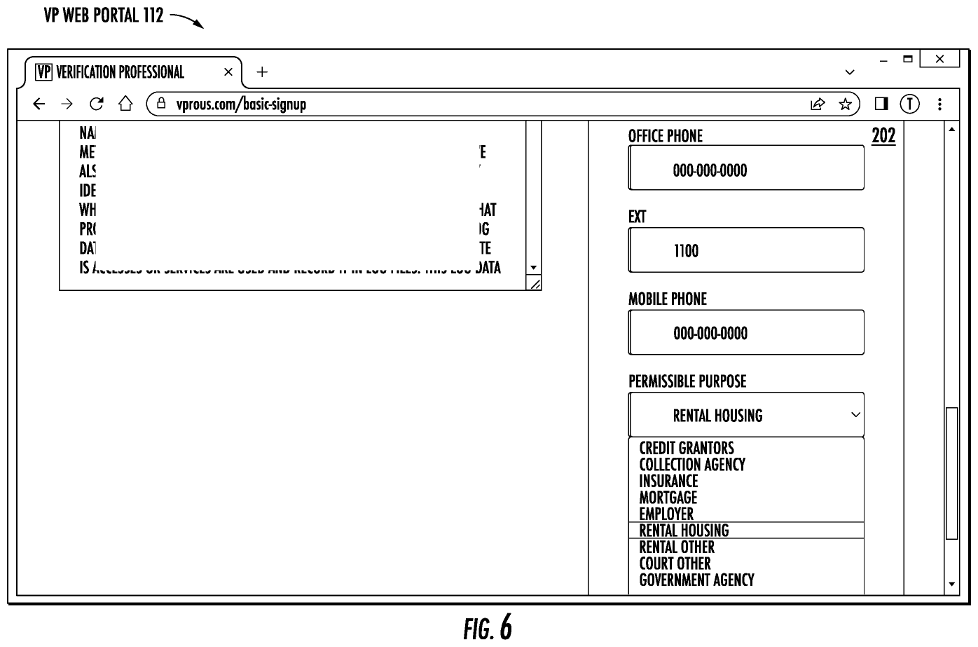

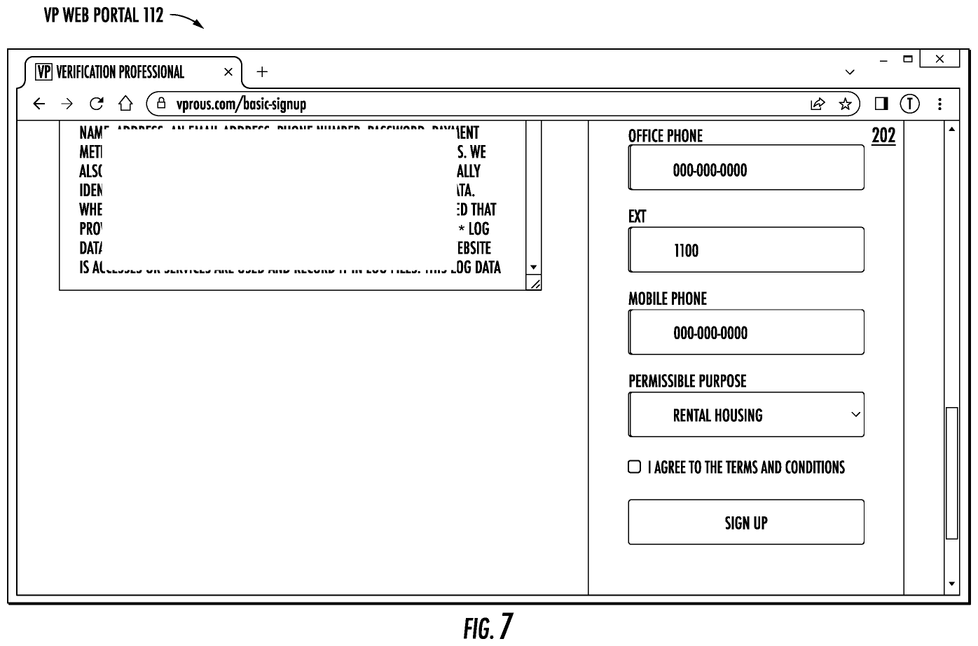

Upon selecting the Login-Register button on home screen 200 of VP web portal 112, the user (e.g., a verifier 172) may be directed to a login screen 202, as shown, for example in FIG. 3 through FIG. 7. More specifically, FIG. 3 through FIG. 7 are screenshots of an example of login screen 202 and showing an example of a verifier login/account creation process. At FIG. 3, a verifier 172 may select “Create account Home,” with directs to the “Create account” portion of login screen 202 shown in FIG. 4 through FIG. 7. FIG. 4 shows the entry fields for name, email address, and password. FIG. 5 shows the entry fields for mailing address and country. FIG. 6 shows the entry fields for one or more phone numbers. FIG. 6 also shows a dropdown menu for selecting the verifier's “permissible purpose” for requesting the intended verification. Example permissible purposes may include, but is not limited to, credit grantors, collection agency, insurance, mortgage, employer, rental housing, rental other, court order, government agency, open bank account, and/or the like. By way of example, FIG. 7 shows an example selected permissible purpose as rental housing.

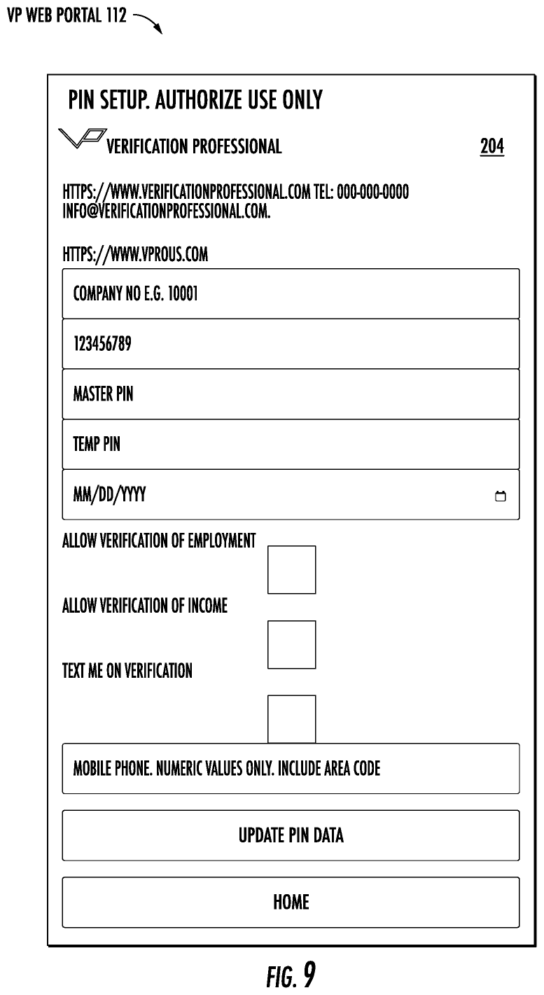

Referring now to FIG. 8 through FIG. 22 are screenshots of an example of an employee PIN setup process using web portal 112 of VOE/VOI system 100 shown in FIG. 1, in accordance with an embodiment of the invention. For example, an employee 170 may select the PIN button on home screen 200 of VP web portal 112, as shown in FIG. 8. In doing so, the employee 170 may be directed to a PIN setup screen 204, as shown, for example in FIG. 9 through FIG. 22.

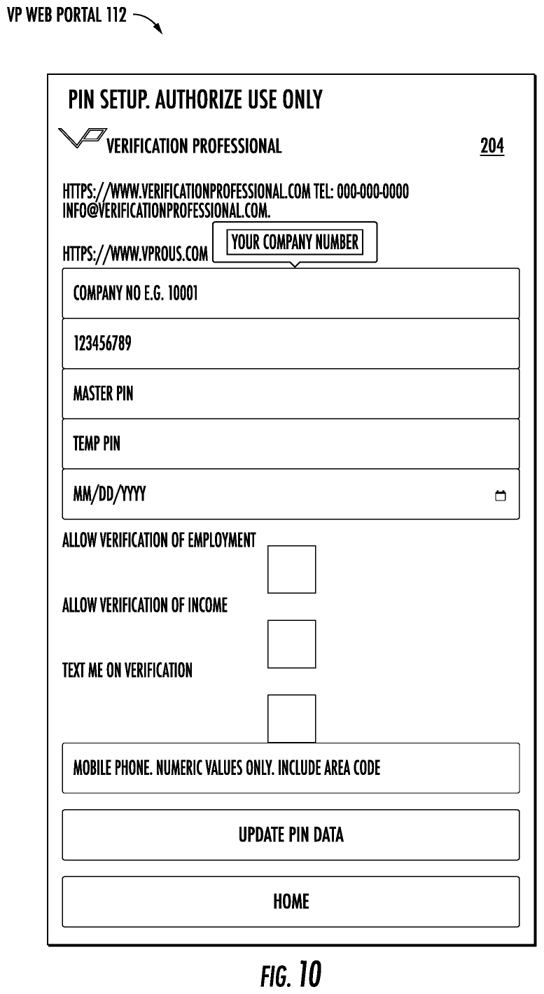

At FIG. 9, PIN setup screen 204 shows entry fields for certain employee information of the employee 170 doing the PIN setup. Now walking through these entry fields, FIG. 10 indicates an entry field for a company number, which is a number (e.g., 5-digit number) assigned to the employer 160 of the employee 170. Each employer 160 of VOE/VOI system 100 is assigned a unique company number. The entering employee 170 knows the unique company number of his/her employer 160.

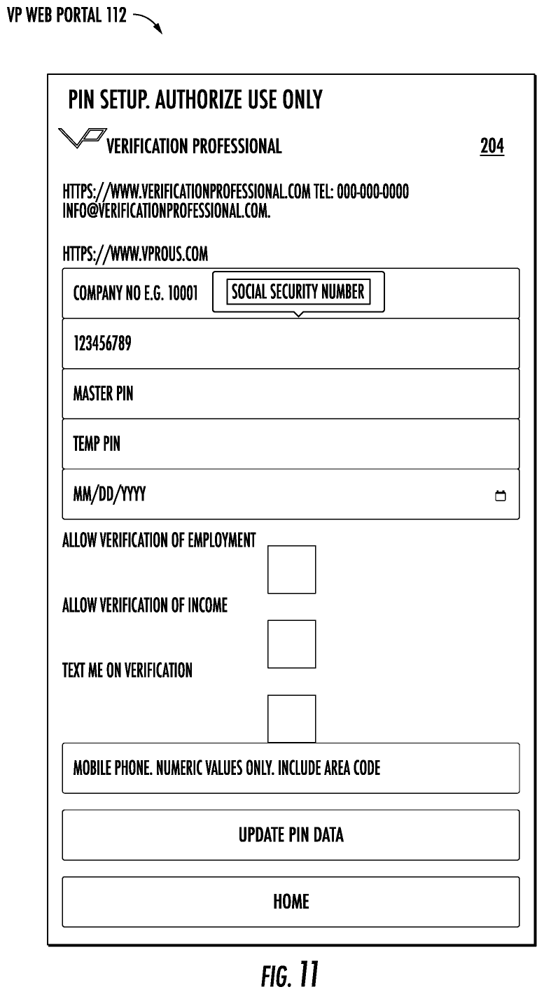

Next, FIG. 11 indicates an entry field for the social security number of the entering employee 170.

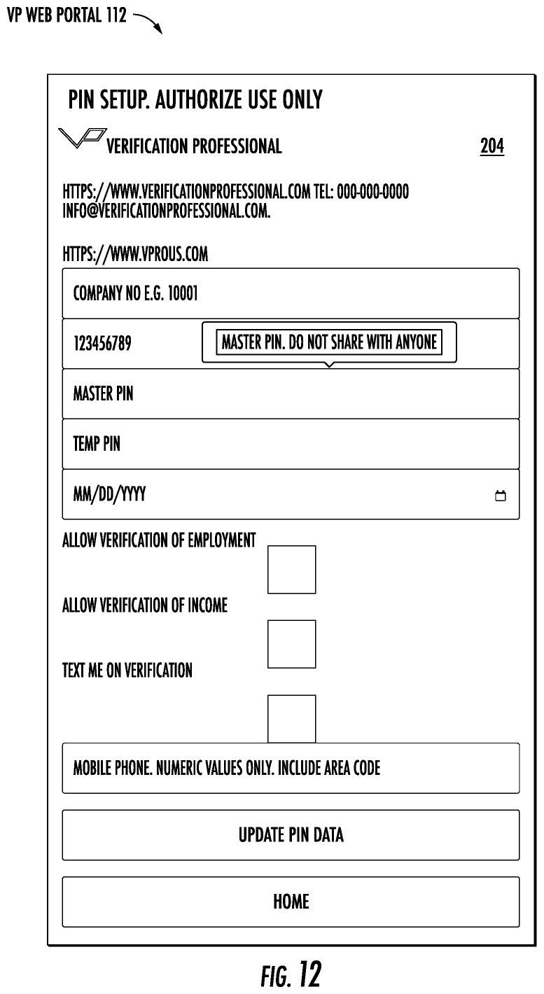

Next, FIG. 12 indicates an entry field for a master PIN number of the entering employee 170. In one example, the employee 170 may receive the master PIN from his/her employer 160. It is intended that the employee 170 not share the master PIN number with any other person or entity. The master PIN may be any combinations of characters or information that only the employee 170 knows. In one example, the master PIN may include the last 4 digits of the employee 170's social security number plus his/her hire date plus his/her birth year plus his/her birth month, and so on. The use of the master PIN in the PIN setup process essentially facilitates a login process for the employee 170. The master PIN number and the temporary PIN number are “write-only” fields, not readable fields.

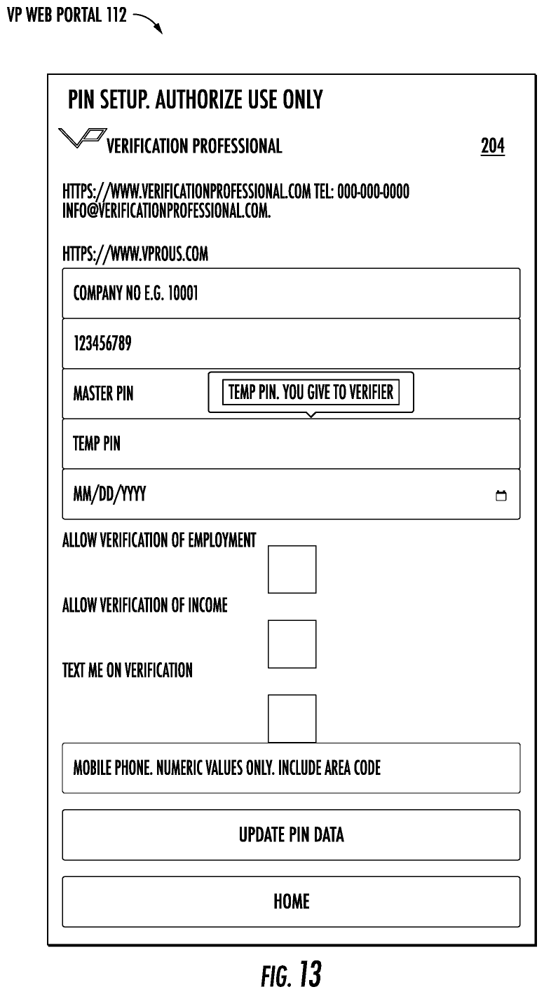

Next, FIG. 13 indicates an entry field for a temporary PIN number of the entering employee 170. It is intended that the temporary PIN number be shared with a certain verifier 172 only. In one example, the temporary PIN number may be a 4-digit number.

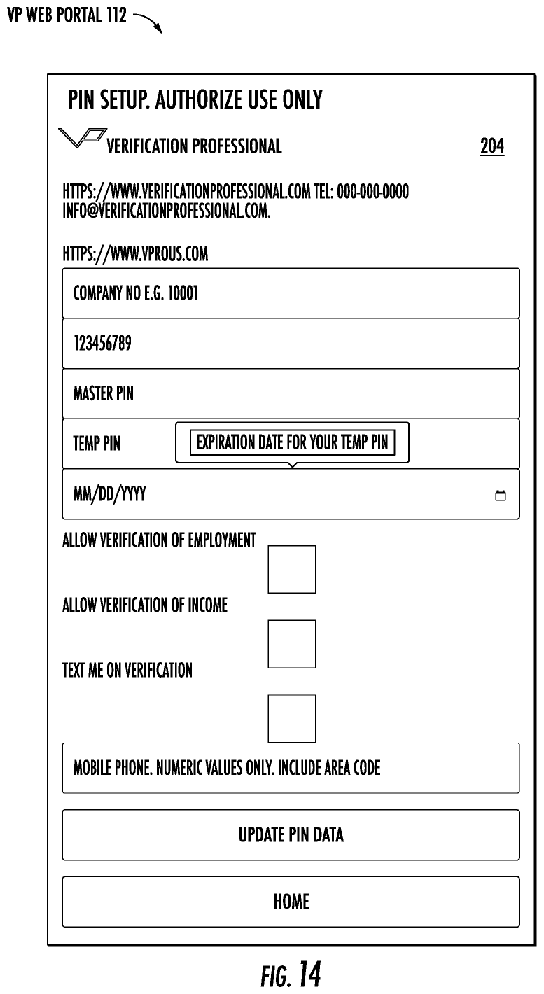

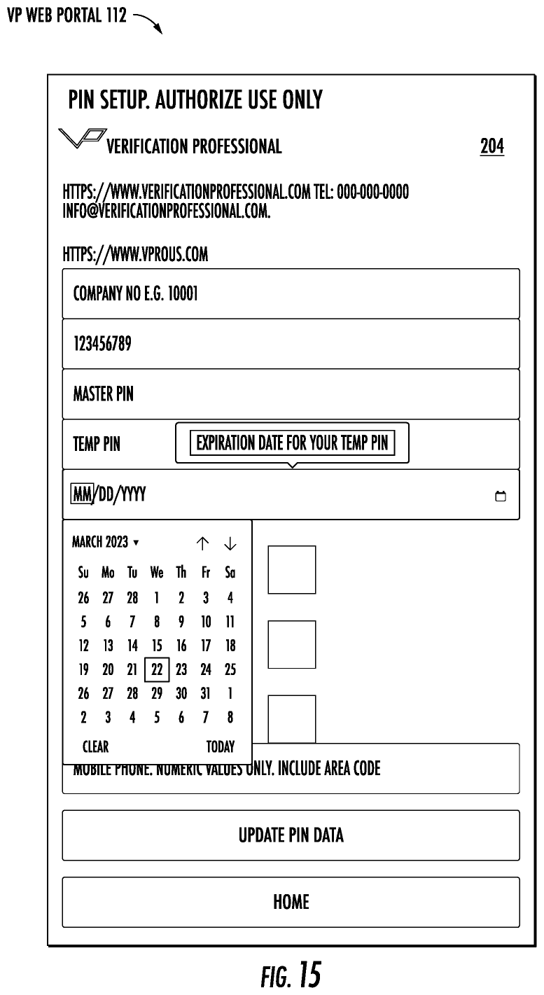

Next, FIG. 14 indicates an entry field for the expiration date of the temporary PIN number set in the previous entry field. The expiration date means a date after which the certain verifier 172 will not be allowed to perform the VOE/VOI event. FIG. 15 shows a dropdown menu for selecting the PIN expiration date.

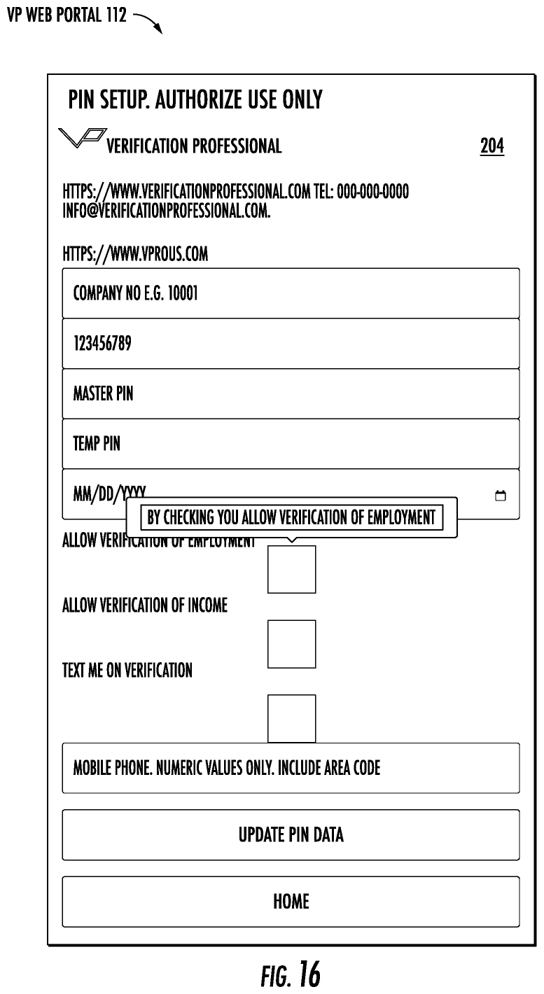

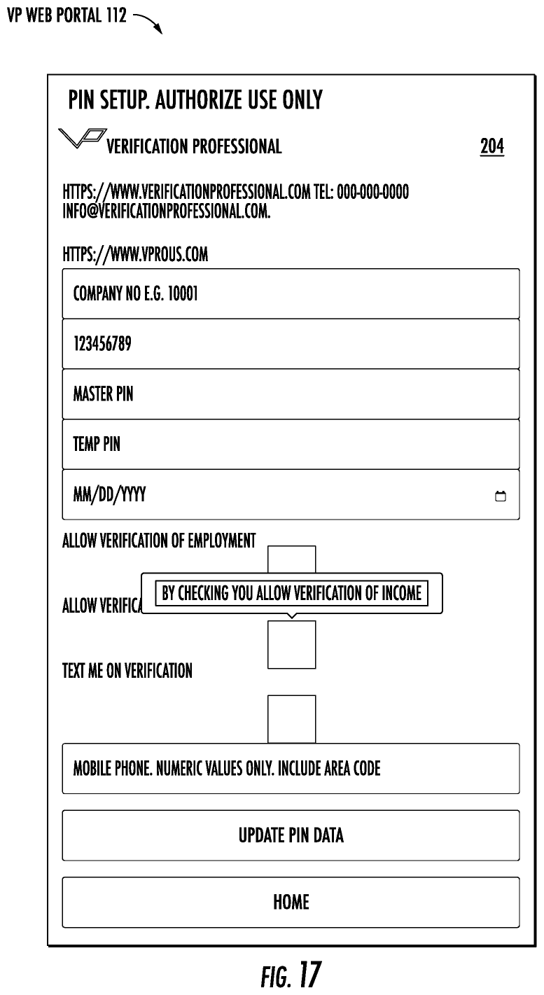

Next, FIG. 16 shows a check box for allowing a verification of employment (i.e., a VOE event). Further, FIG. 17 shows a check box for allowing a verification of income (i.e., a VOI event). The two check boxes provide a means by which the employee 170 may control his/her data; namely, his/her employment information and income information, respectively.

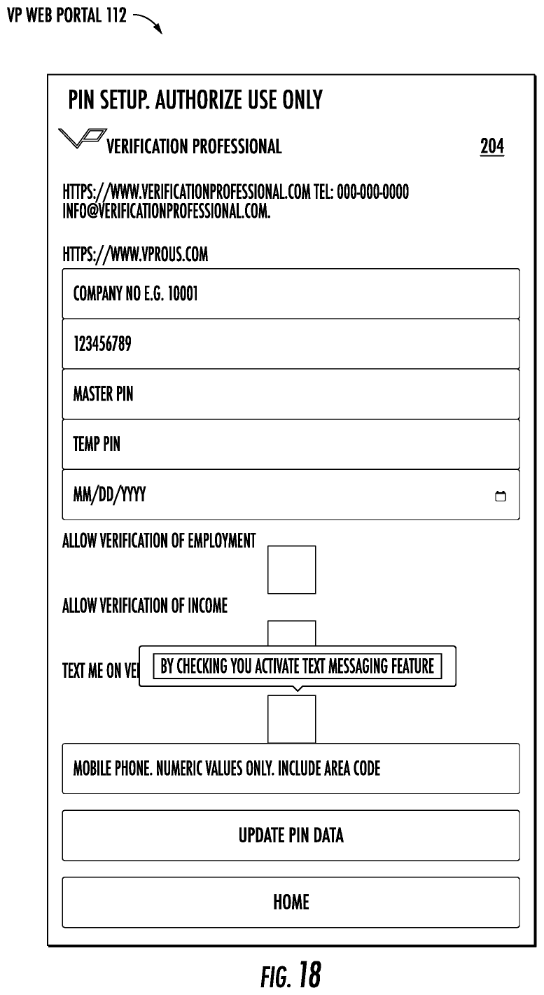

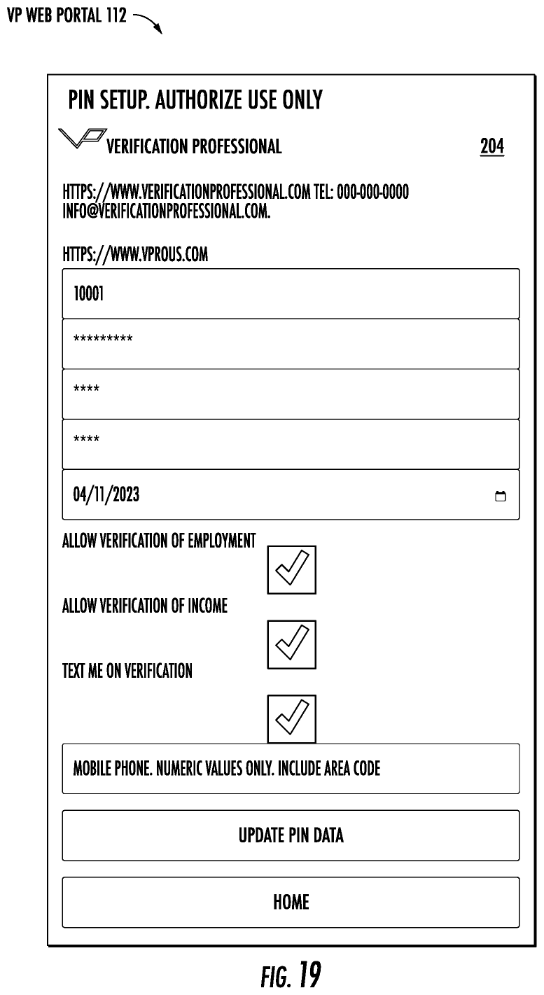

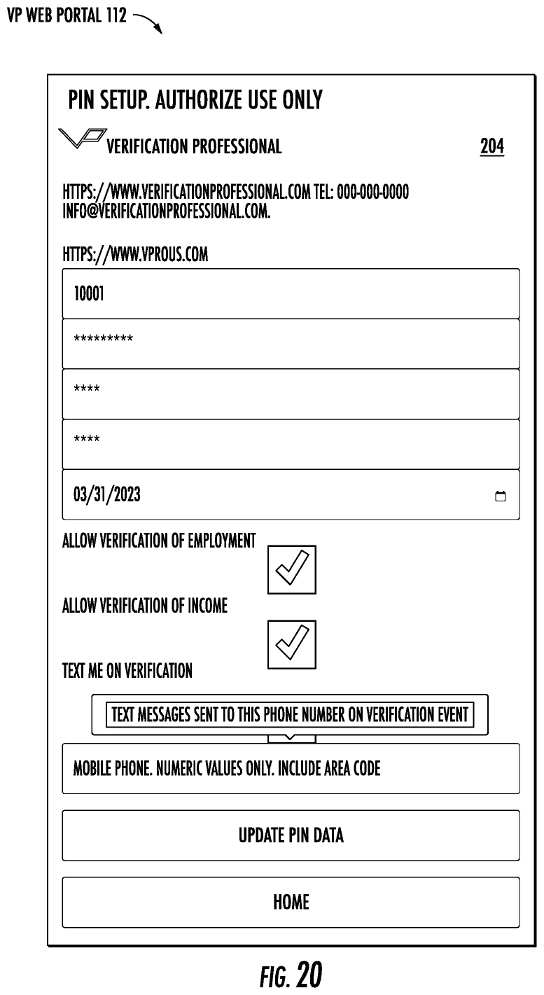

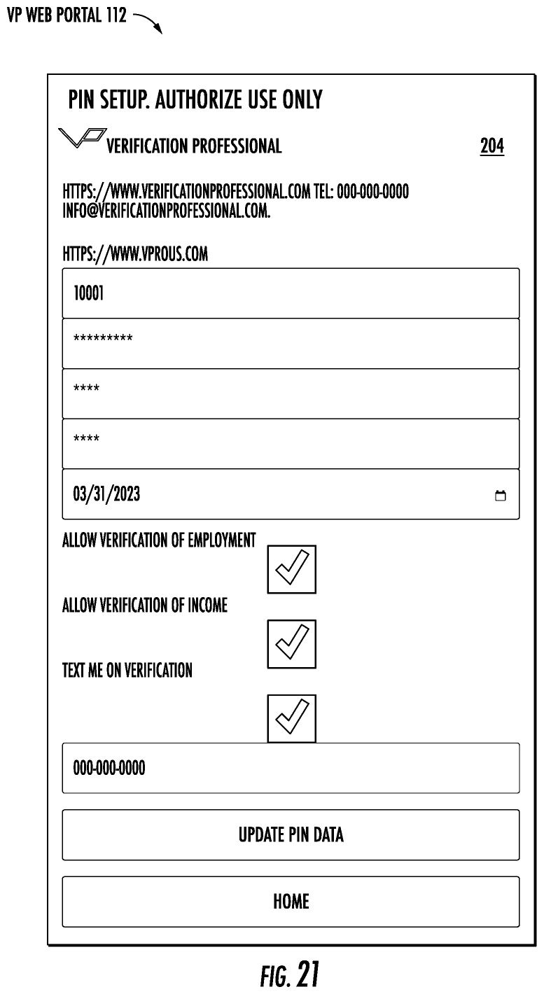

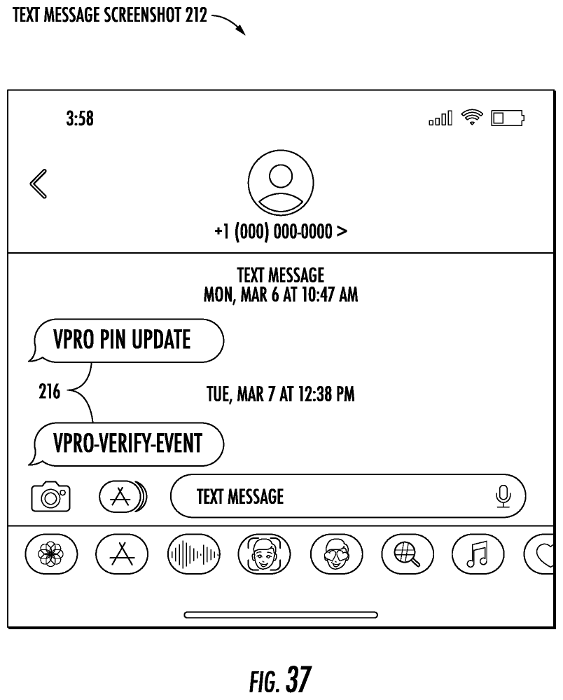

Next, FIG. 18 shows a check box for allowing text message notifications to the entering employee 170. Next, FIG. 19 shows an example of the VOE check box, the VOI check box, and the text message check box selected, meaning VOE, VOI, and text messaging are allowed. Next, FIG. 20 and FIG. 21 indicate an entry field for the mobile phone number of the entering employee 170. The mobile phone number is required when the text message check box is selected. Examples of text message notifications are “VPro PIN Update” (see FIG. 37) and “VPro Verify Event” (see FIG. 37).

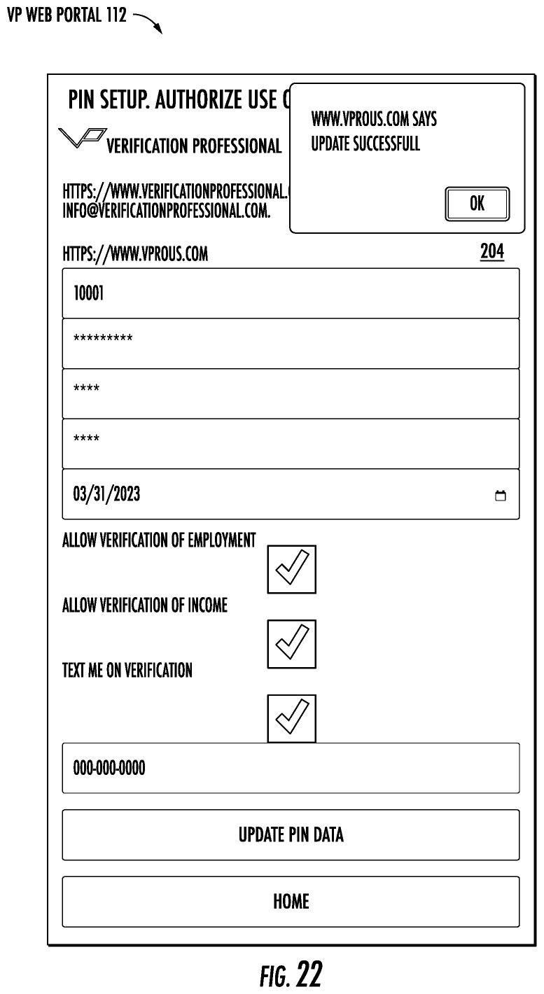

Next, PIN setup screen 204 may include an “Update PIN Data” button and a “Home” button. FIG. 22 shows that when “Update PIN Data” is selected a confirmation pop-up (e.g., Update Successful) may be displayed at PIN setup screen 204.

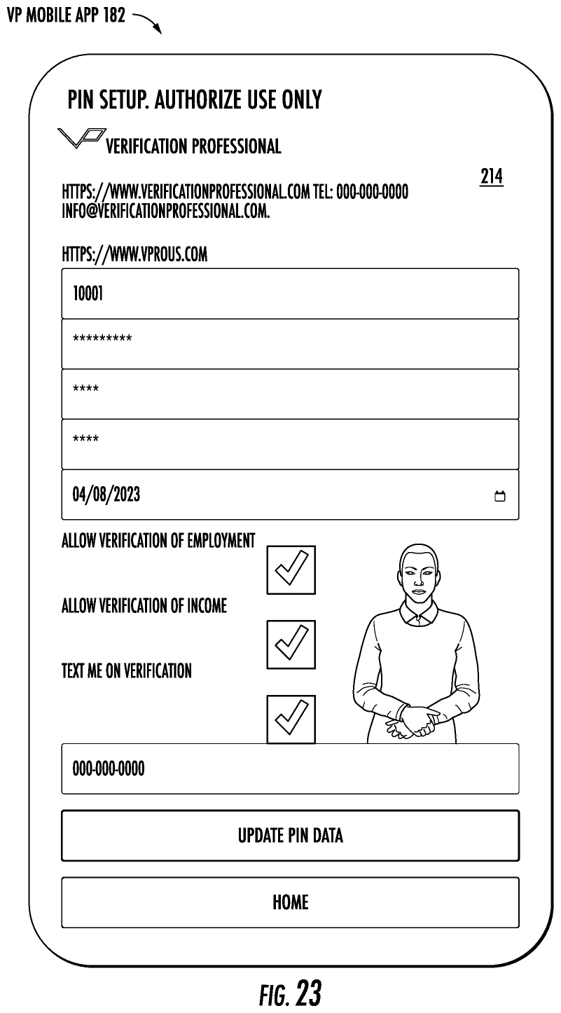

Referring now to FIG. 23 is a screenshot of an example of a PIN setup screen 214 of VP mobile app 182 of VOE/VOI system 100 shown in FIG. 1, in accordance with an embodiment of the invention. PIN setup screen 214 of VP mobile app 182 of VOE/VOI system 100 may be used in substantially the same or similar fashion as PIN setup screen 204 of VP web portal 112 shown in FIG. 8 through FIG. 22.

Referring still to PIN setup screen 204 shown in FIG. 9 through FIG. 22, a main feature of VP application 110 of VOE/VOI system 100 it that it supports a PIN-based verification process that uses both a master PIN of the employee 170 that is not shared and a temporary PIN of the employee 170 that may be shared for a limited amount of time with a certain verifier 172.

Referring now to FIG. 24 through FIG. 31 is screenshots of an example of a verification request process using web portal 112 of VOE/VOI system 100 shown in FIG. 1, in accordance with an embodiment of the invention.

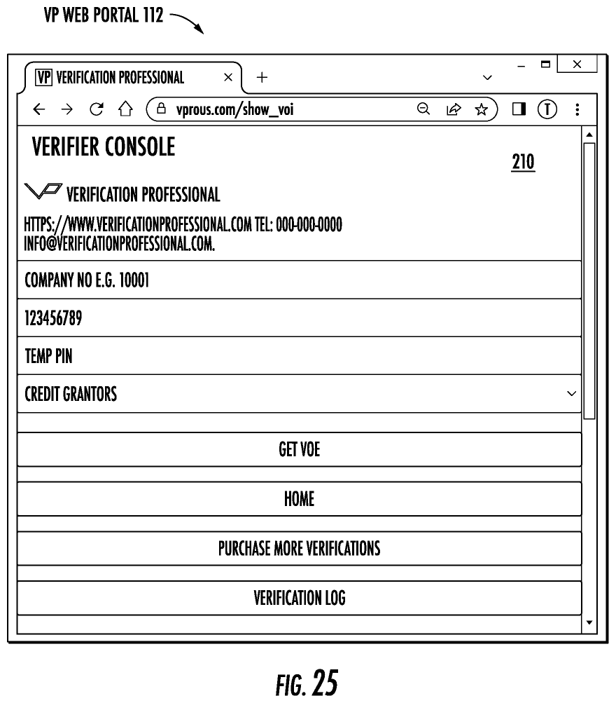

For example, after logging into VOE/VOI system 100, a verifier 172 may select the Services button on home screen 200 of VP web portal 112, as shown in FIG. 24. In doing so, the verifier 172 may be directed to a verifier console screen 210, as shown, for example in FIG. 25 through FIG. 31.

In advance of using verifier console screen 210 of VP web portal 112 of VOE/VOI system 100, the verifier 172 will have acquired the necessary information about the employee 170 who is the subject of the verification. For example, the verifier 172 will have acquired the name of the employee 170, the company number of the employer 160 of the employee 170, the social security number of the employee 170, and the temporary PIN number of the employee 170.

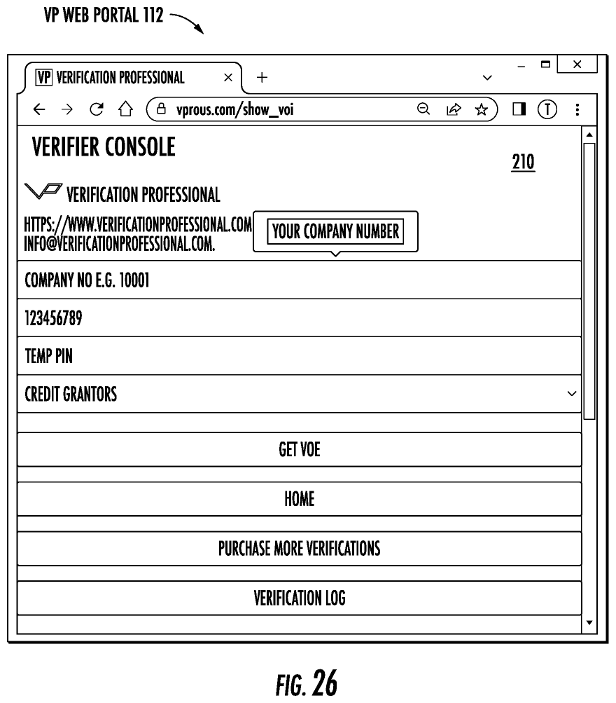

At FIG. 25, verifier console screen 210 shows entry fields for information about the employee 170 who is the subject of the verification. Now walking through these entry fields, FIG. 26 indicates an entry field for the company number of the employer 160 of the employee 170 who is the subject of the verification.

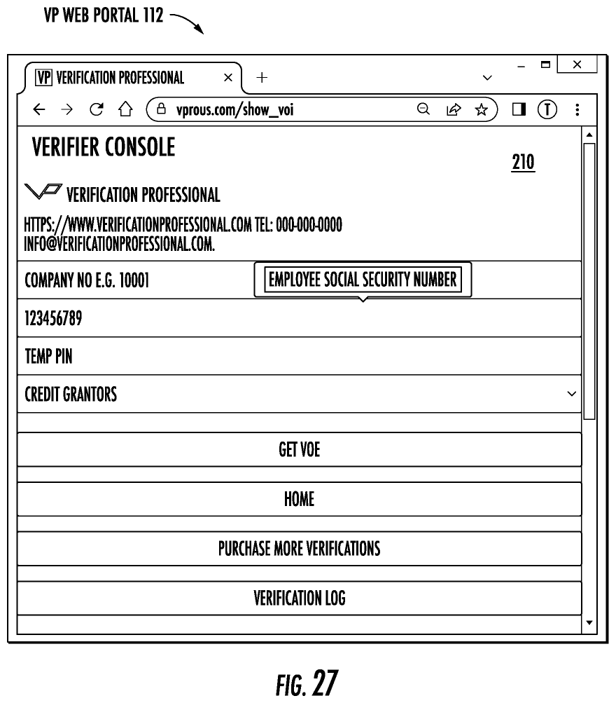

Next, FIG. 27 indicates an entry field for the social security number of the entering employee 170 who is the subject of the verification.

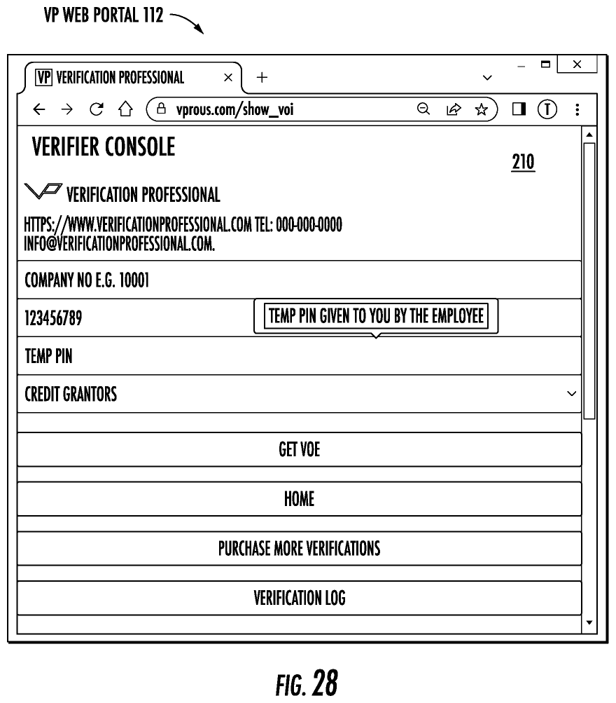

Next, FIG. 28 indicates an entry field for a temporary PIN number associated with the employee 170 who is the subject of the verification.

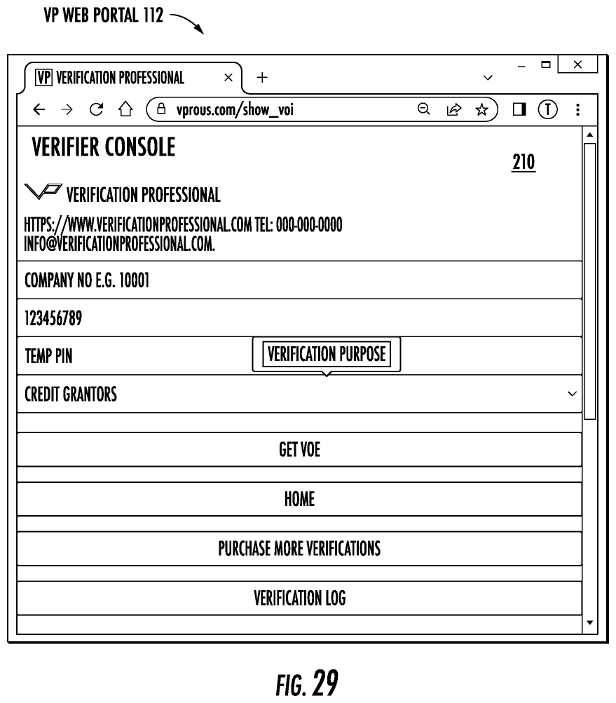

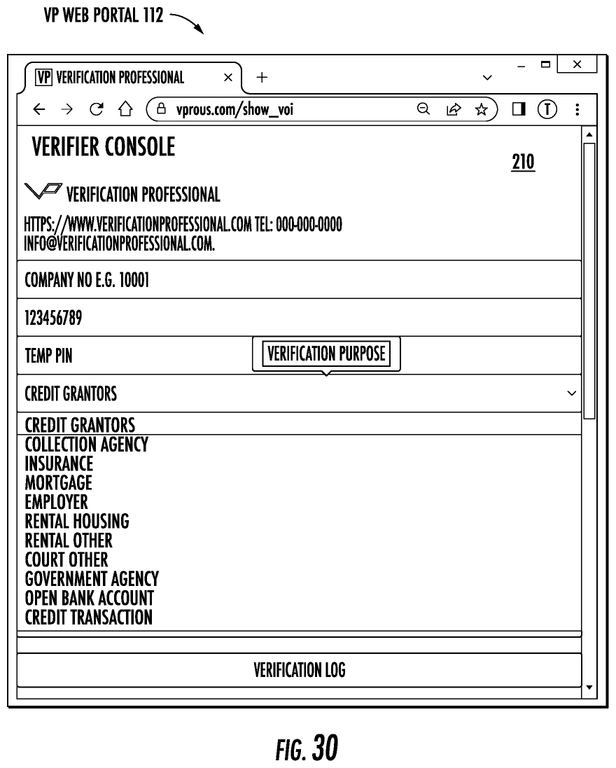

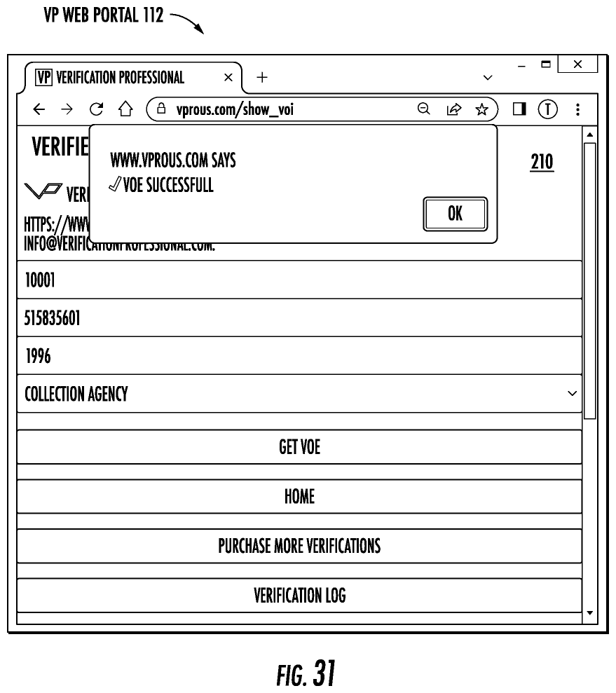

Next, FIG. 29 indicates an entry field for entering a “verification purpose.” FIG. 30 shows a dropdown menu for selecting the “verification purpose.” Example verification purposes may include credit grantors, collection agency, insurance, mortgage, employer, rental housing, rental other, court order, government agency, open bank account, and the like. By way of example, FIG. 31 shows the selected verification purpose as collection agency.

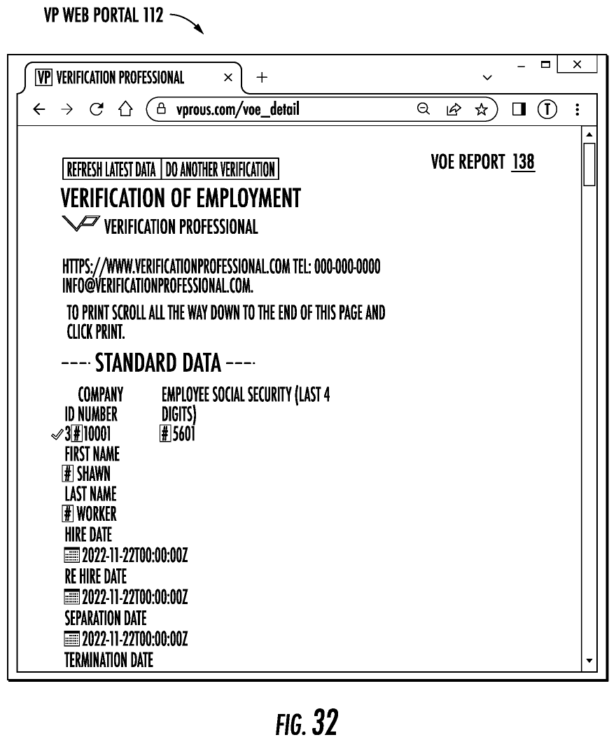

Further, verifier console screen 210 may include an “Get VOE” button, a “Home” button, a “Purchase More Verifications” button, and a “Verification Log” button. FIG. 31 shows that when “Get VOE” is selected a confirmation pop-up (e.g., VOE Successful) may be displayed at verifier console screen 210. Further, FIG. 32 through FIG. 36 shows an example of a VOE report 138, which is the result of the verification request process shown in FIG. 24 through FIG. 31.

Referring now to FIG. 37 is a text message screenshot 212 of an example of text messages 216 received by an employee 170 being verified using VOE/VOI system 100 shown in FIG. 1, in accordance with an embodiment of the invention.

In one example, text message 216 may be “VPro PIN Update.” This is an example of the text message that may be automatically sent by VP application 110 at the completion of the PIN setup process that is performed by the employee 170 and shown in FIG. 8 through FIG. 22.

In another example, text message 216 may be “VPro Verify Event.” This is an example of the text message that may be automatically sent by VP application 110 at the completion of the verification request process that is performed by the verifier 172 and shown in FIG. 24 through FIG. 36.

In yet another example, the “VPro Verify Event” text message 216 may in include more details, such has who verified and the verification date. For example:
VPRO-EVENT-john.smith@acme.com Verified you on income
   Company-Acme
   Date-March-22-2023

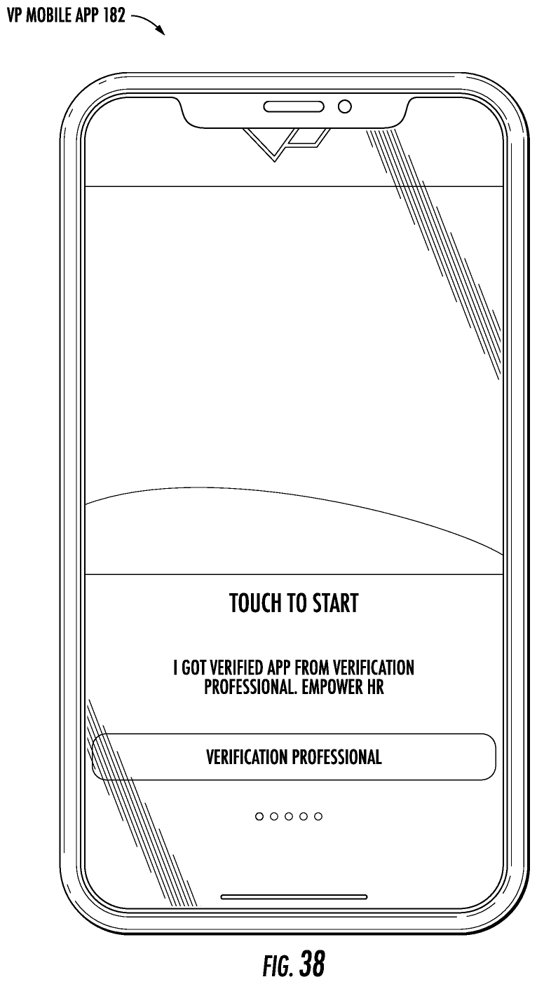

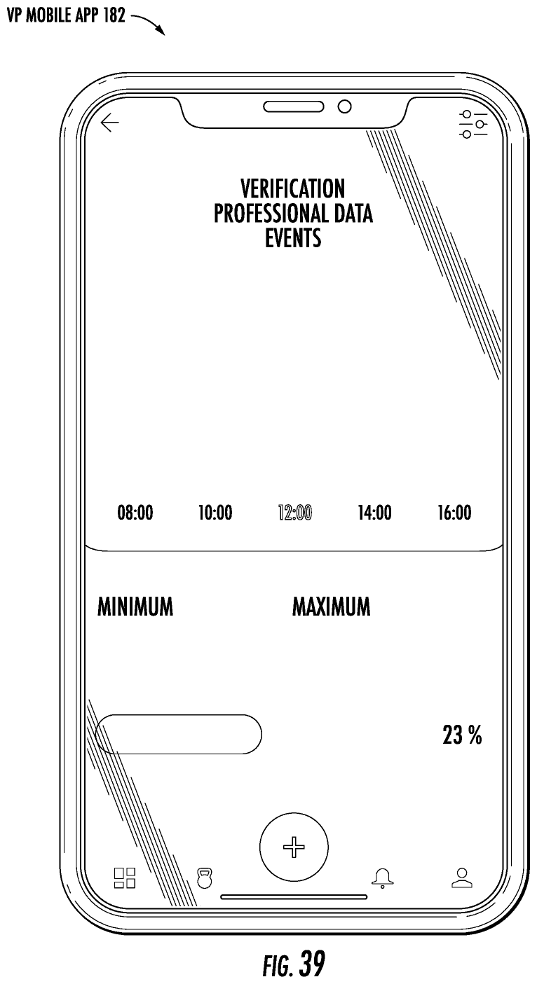

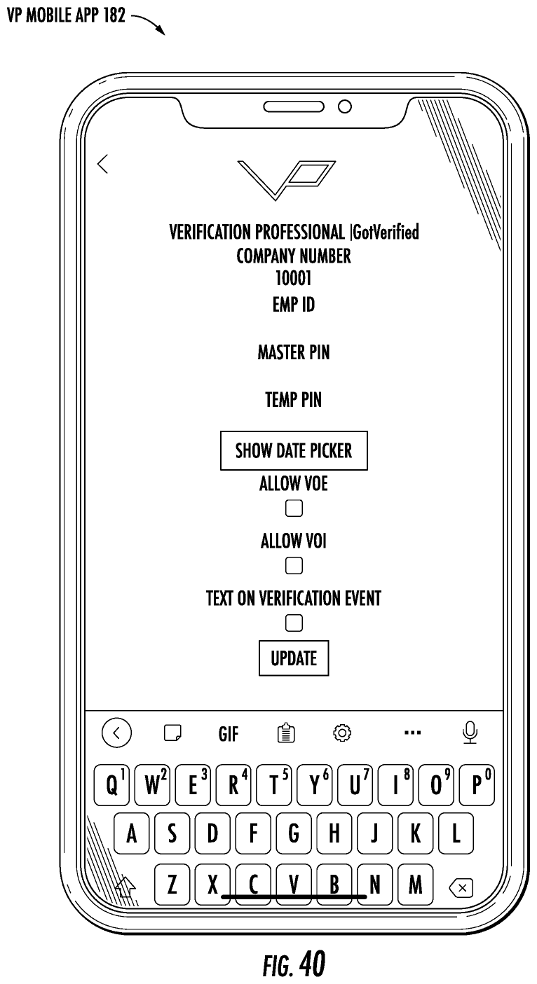

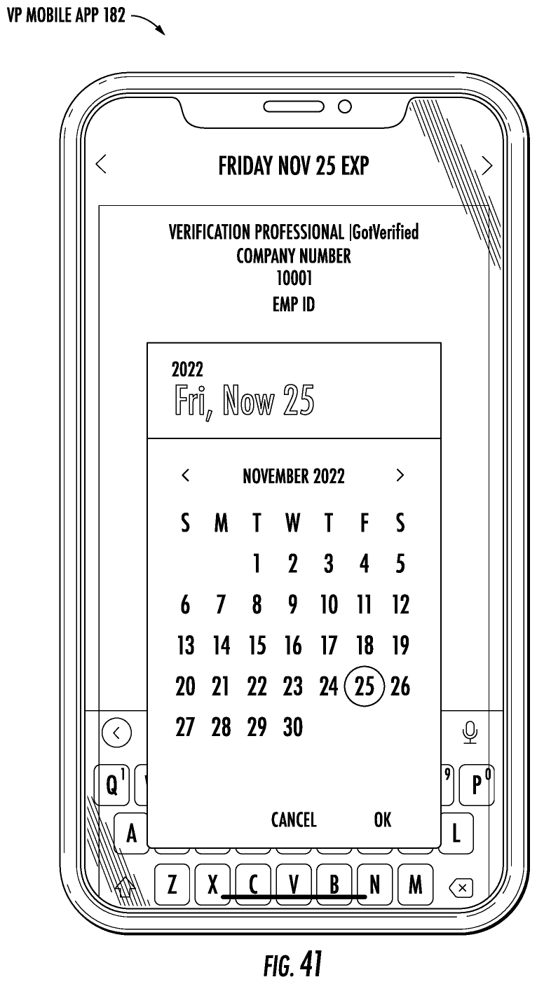

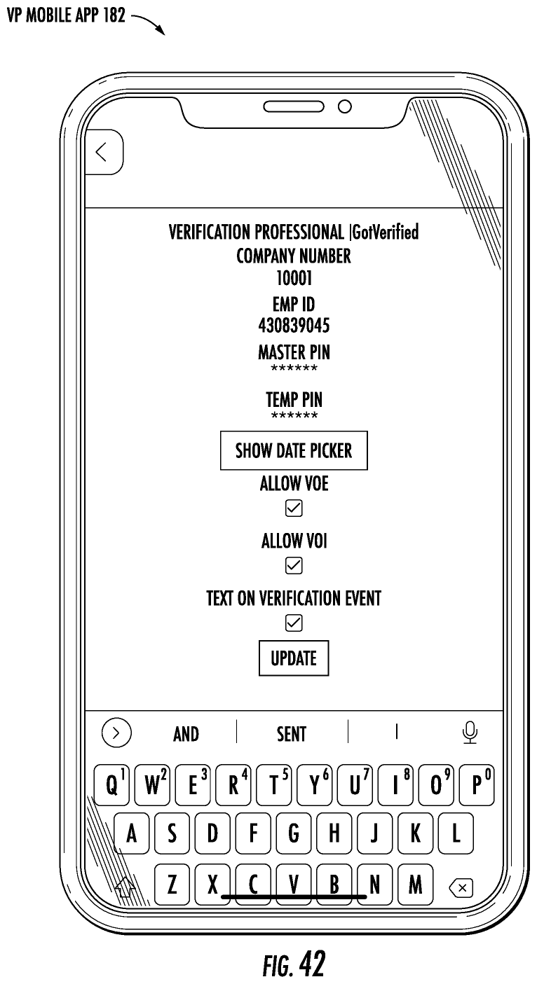

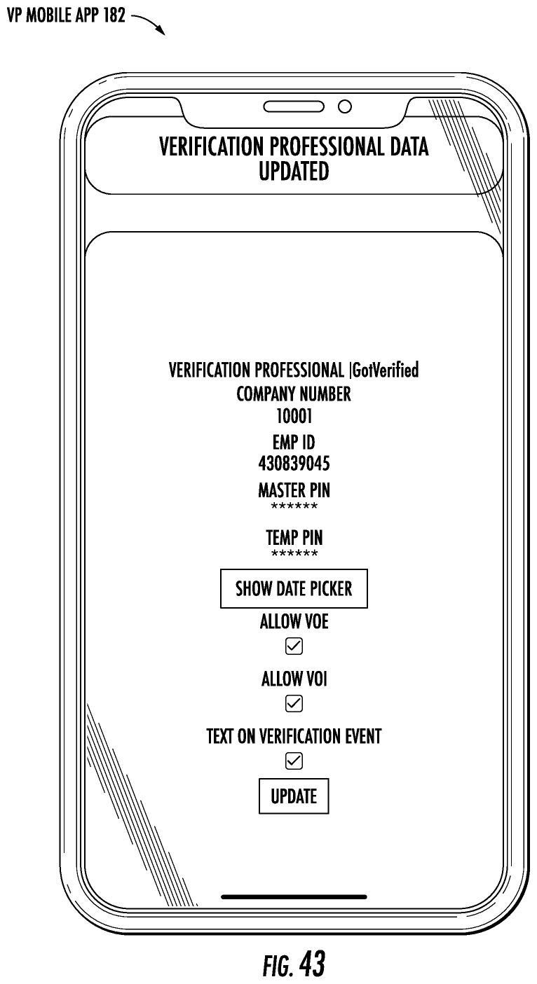

Referring now to FIG. 38 through FIG. 43 is more screenshots of an example of VP mobile app 182 of VOE/VOI system 100 shown in FIG. 1, in accordance with an embodiment of the invention.

Referring now to FIG. 44 is a flow diagram of an example of a method 300 of an employee 170 using VOE/VOI system 100 shown in FIG. 1, in accordance with an embodiment of the invention. The employee 170 may use PIN setup screen 204 of VP web portal 112 of VOE/VOI system 100 for performing the steps of method 300 (see FIG. 9 through FIG. 22). Method 300 may include, but is not limited to, the following steps.

At a step 310, a VOE/VOI system is provided in accordance with an embodiment of the invention. For example, VOE/VOI system 100 including VP application 110 and data store 130 running on application server 145 as described above in FIG. 1 through FIG. 43 is provided.

At a step 315, an employee to be verified accesses the website or mobile app of the VOE/VOI system. For example, an employee 170 to be verified opens VP web portal 112 (see FIG. 8 through FIG. 22) or VP mobile app 182 (see FIG. 23) of VOE/VOI system 100.

At a step 320, the employee to be verified sets a temporary PIN number and a temporary PIN expiration date on the VOE/VOI system. For example, and referring now again to FIG. 8 through FIG. 22, the employee 170 to be verified enters his/her company number (see FIG. 10), social security number (see FIG. 11), and master PIN number (see FIG. 12). Then, the employee 170 to be verified enters his/her temporary PIN number (see FIG. 13) and temporary PIN expiration date (see FIG. 14 and FIG. 15).

At a step 325, the employee to be verified selects the type of verification to allow and provides a mobile phone number. For example, and referring now again to FIG. 8 through FIG. 22, the employee 170 to be verified selects the VOE check box (see FIG. 16) or the VOI check box (see FIG. 17) or both the VOE and VOI check boxes (see FIG. 19). Further, the employee 170 may select the text message check box (see FIG. 18 and FIG. 20) and then enter his/her mobile phone number (see FIG. 21).

At a step 330, the VOE/VOI system automatically notifies the employee of the PIN update. In one example, upon submitting “Update PIN Data” (see FIG. 22), VP notification module 114 of VP application 110 automatically generates and sends a text message to the employee 170 indicating that a PIN update event has occurred. For example, FIG. 37 shows the “VPro PIN Update” text message 216 that may be sent to the mobile phone of the employee 170. In another example, VP notification module 114 of VP application 110 automatically notifies the employee 170 of the PIN update via a pop-up of VP mobile app 182 and/or VP desktop application 184. Further, this step of method 300 is not limited to text message notification only. Other types of notification are possible, such as, but not limited to, email and recorded phone calls.

At a step 335, the employee to be verified provides the verifier with the temporary PIN number and any other information and then directs the verifier to the VOE/VOI system. For example, the employee 170 to be verified provides the verifier 172 with the temporary PIN number and any other information (e.g., company number, social security number) and then directs the verifier 172 to VOE/VOI system 100. More specifically, the verifier 172 may be directed to a method 400 shown and described below in FIG. 45.

Referring now to FIG. 45 is a flow diagram of an example of method 400 of a verifier 172 using VOE/VOI system 100 shown in FIG. 1, in accordance with an embodiment of the invention. In advance of using method 400, the verifier 172 will have acquired the necessary information about the employee 170 who is the subject of the verification. For example, the verifier 172 will have acquired the name of the employee 170, the company number of the employer 160 of the employee 170, the social security number of the employee 170, and the temporary PIN number of the employee 170. Further, the verifier 172 may use verifier console screen 210 of VP web portal 112 of VOE/VOI system 100 for performing the steps of method 400 (see FIG. 25 through FIG. 31). Method 400 may include, but is not limited to, the following steps.

At a step 410, a VOE/VOI system is provided in accordance with an embodiment of the invention. For example, VOE/VOI system 100 including VP application 110 and data store 130 running on application server 145 as described above in FIG. 1 through FIG. 43 is provided.

At a step 415, the verifier accesses the website or mobile app of the VOE/VOI system and creates an account on VOE/VOI system. For example, a verifier 172 opens VP web portal 112 or VP mobile app 182 and creates an account on VOE/VOI system 100. In one example, verifier 172 uses login screen 202 of VP web portal 112 to create an account on VOE/VOI system 100 (see FIG. 2 through FIG. 7).

At a step 420, the verifier sets the permissible purpose for requesting the VOE/VOI. For example, and referring now again to FIG. 6 and FIG. 7, using login screen 202 the verifier 172 may select the permissible purpose for requesting the VOE/VOI. Examples of permissible purposes (or verification purposes) may include credit grantors, collection agency, insurance, mortgage, employer, rental housing, rental other, court order, government agency, open bank account, and the like.

At a step 425, the verifier enters the temporary PIN number and any other information about the employee to be verified. For example, using verifier console screen 210 of VP web portal 112, the verifier 172 may enter the company number of the employer 160 of the employee 170 (see FIG. 26), the social security number of the employee 170 (see FIG. 27), and the verification purpose (see FIG. 29 and FIG. 30). Then, using verifier console screen 210 of VP web portal 112, the verifier 172 may enter the temporary PIN number of the employee 170 (see FIG. 28).

At a step 430, the verifier submits the request for VOE and/or VOI on the VOE/VOI system. For example, by selecting “Get VOE” on verifier console screen 210 of VP web portal 112, the verifier 172 may submit the request for VOE and/or VOI on the VOE/VOI system 100 (see FIG. 31).

At a step 435, the VOE/VOI system returns to the verifier the VOE/VOI report about the employee to be verified. For example, VP application 110 returns to the verifier 172 the VOE/VOI report about the employee 170 to be verified. FIG. 32 through FIG. 36 shows an example of a VOE report 138 that may be automatically generated and presented and/or printed.

At a step 440, the VOE/VOI system automatically notifies the employee of the verification event. In one example, a text message that may be automatically sent to the employee 170 by VP notification module 114 of VP application 110 upon receipt of the verification request. For example, FIG. 37 shows the “VPro Verify Event” text message 216 that may be sent to the mobile phone of the employee 170. In another example, VP notification module 114 of VP application 110 automatically notifies the employee 170 of the verification event via a pop-up of VP mobile app 182 and/or VP desktop application 184. Further, step 440 of method 400 is not limited to text message notifications only. Other types of notifications are possible, such as, but not limited to, email and recorded phone calls.

Further, step 440 of method 400 is not limited to sending notifications to employee 170 only. In other embodiments, the verifier 172 may also receive notification of the VOE/VOI event. For example, both the employee 170 and the verifier 172 may receive the “VPro Verify Event” text message 216.

In summary and referring now again to FIG. 1 through FIG. 45, VOE/VOI system 100 and methods 300, 400 provide VP application 110 and data store 130 running on application server 145 that supports VP web portal 112 as well as VP mobile app 182 running on any mobile device.

In some embodiments, VOE/VOI system 100 and methods 300, 400 provide VP application 110 that supports a PIN-based verification process that uses both a master PIN of the employee 170 being verified that is not shared and a temporary PIN of the employee 170 that may be shared for a limited amount of time with a certain verifier 172.

In some embodiments, VOE/VOI system 100 and methods 300, 400 provide mechanisms for employee information control, such as VOE check box (see FIG. 16 and FIG. 21) and the VOI check box (see FIG. 17 and FIG. 21) of PIN setup screen 204.

In some embodiments, VOE/VOI system 100 and methods 300, 400 provide mechanisms for employee notifications, such as text message check box (see FIG. 18 and FIG. 21) of PIN setup screen 204.

In some embodiments, VOE/VOI system 100 and methods 300, 400 provide mechanisms for employee notifications, such as, but not limited to, an automatic text message or pop-up notification of a PIN update, an automatic text message or pop-up notification of a verification event, and the like.

In some embodiments, VOE/VOI system 100 and methods 300, 400 provide mechanisms for employee notifications and wherein these automatic notifications may provide a security benefit, such as notification by text message of a PIN update that may be unauthorized.

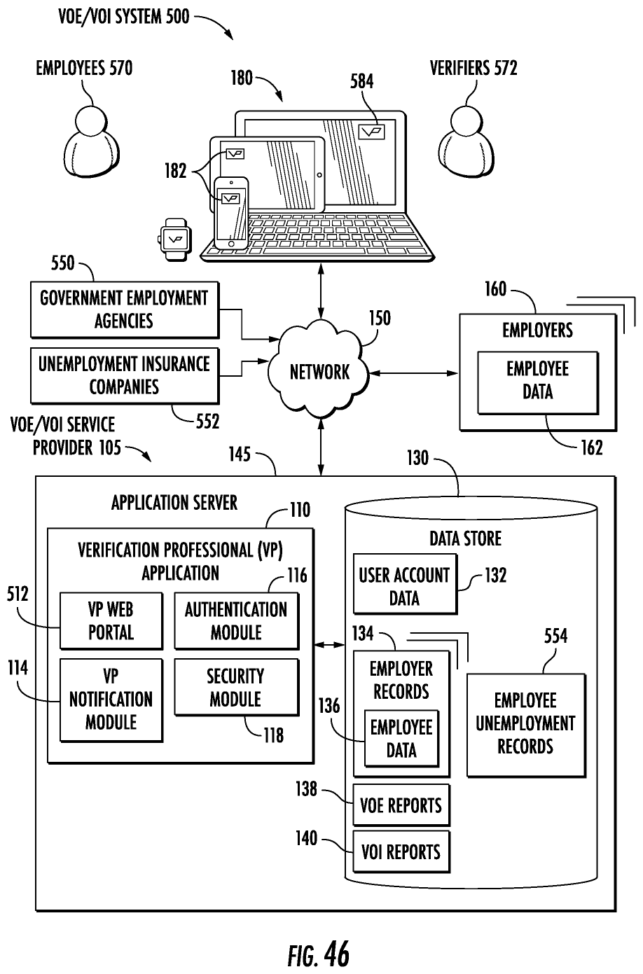

Referring now to FIG. 46 is a block diagram of an example of a VOE/VOI system 500 including employee information control and employee notifications with respect to verifying unemployment claims and/or benefits, in accordance with an embodiment of the disclosure. VOE/VOI system 500 may be substantially the same as VOE/VOI system 100 described above in FIG. 1 through FIG. 45 except further including features with respect to notifications about unemployment claims and/or benefits.

For example, like VOE/VOI system 100 shown in FIG. 1, VOE/VOI system 500 may be provided in a networked computing configuration that includes VP application 110 and data store 130 running on application server 145. Further, VOE/VOI system 500 may include other networked entities related to employment/unemployment. For example, VOE/VOI system 500 may include government employment agencies 550 and unemployment insurance companies 552. Generally, there is not a federal unemployment program and therefore each state manages its own unemployment insurance program and pays benefits. Accordingly, government employment agencies 550 may be state employment agencies. The North Carolina Division of Employment Security may be an example of a government employment agency 550. However, the U.S. Department of Labor may be another example of a government employment agency 550. Unemployment insurance companies 552 may be any unemployment insurance companies that manage unemployment claims and/or benefits. In some instances, unemployment insurance companies 552 may be working on behalf of government employment agencies 550.

VOE/VOI system 500 may include the employers 160 as described above in VOE/VOI system 100. VOE/VOI system 500 may further include employees 570 and verifiers 572. Like employees 170, employees 570 may be the persons who are the subject of the VOE/VOI requests—the “verifyees.” However, in VOE/VOI system 500, employees 570 may further include any unemployed individuals. In the context of VOE/VOI system 500, employees 570 are hereafter called unemployed employees 570.

Like verifiers 172, verifiers 572 may be the entities seeking the VOE/VOI information. Examples of verifiers 572 may include, but are not limited to, creditors, collection agencies, insurance companies, mortgage companies, loan companies, rental agencies, and banks. However, in VOE/VOI system 500, verifiers 572 may further include government employment agencies 550 and/or unemployment insurance companies 552.

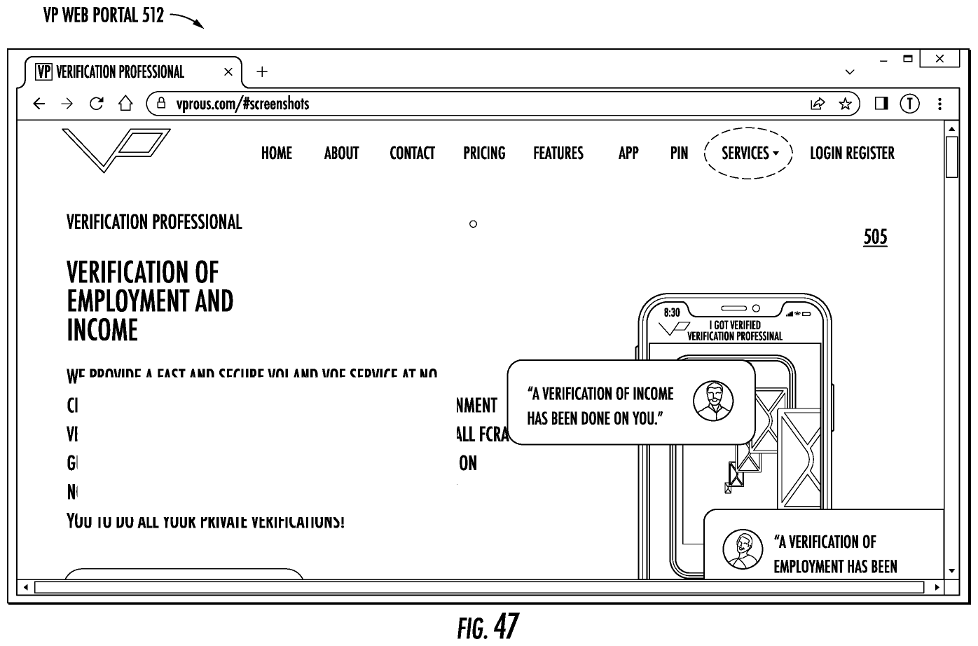

At application server 145, VP application 110 may include a VP web portal 512. A screenshot of an example home screen 505 of VP web portal 512 of VOE/VOI system 500 is shown in FIG. 47. The home screen 505 of VP web portal 512 indicates capabilities to manage verification of employment and income and also of unemployment. VP web portal 512 may be substantially the same as VP web portal 112 of VOE/VOI system 100 except that it is designed to further manage verification of unemployment claims and/or benefits.

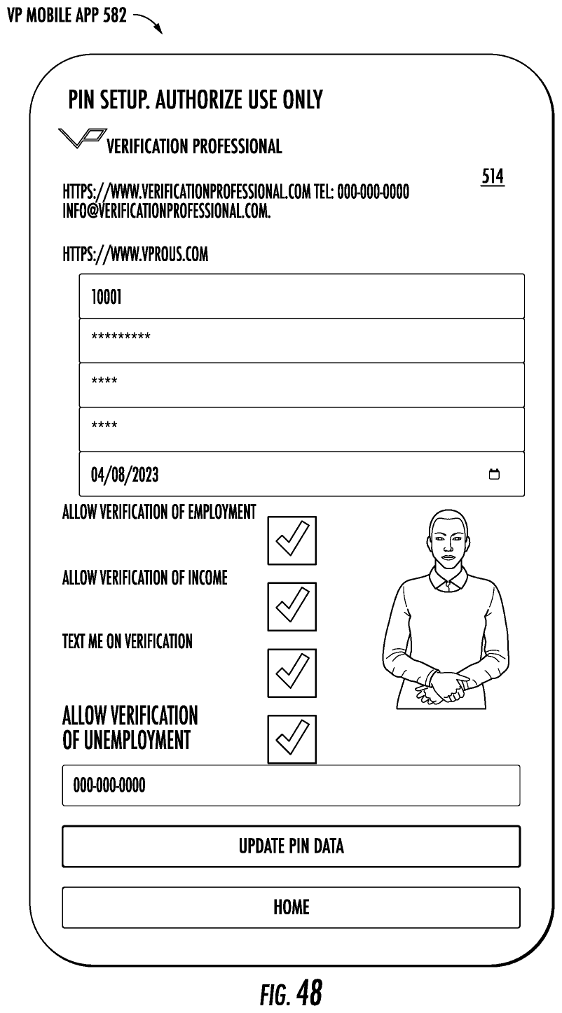

Like VOE/VOI system 100 shown in FIG. 1, VP application 110 of VOE/VOI system 500 may also include the VP notification module 114, authentication module 116, and security module 118. In VOE/VOI system 500, VP application 110 may support a VP mobile app 582 and a VP desktop application 584. A screenshot of an example PIN setup screen of VP mobile app 582 is shown in FIG. 48. For example, FIG. 48 shows a PIN setup screen 514 of VP mobile app 582. VP mobile app 582 may be substantially the same as VP mobile app 182 of VOE/VOI system 100 except that it is designed to further manage verification of unemployment claims and/or benefits. VP web portal 512, VP mobile app 582, and/or VP desktop application 584 may be used for accessing, processing, and displaying unemployment information.

Like VOE/VOI system 100 shown in FIG. 1, user account data 132, employer records 134 including employee data 136, VOE reports 138, and VOI reports 140 may be stored at data store 130 of VOE/VOI system 500. Further, employee unemployment records 554 may be stored in data store 130. Using VP web portal 512, VP mobile app 582, and/or VP desktop application 584, unemployed employees 570 and/or verifiers 572 may access VP application 110 of VOE/VOI system 500 via their respective user computers 180 and network 150.

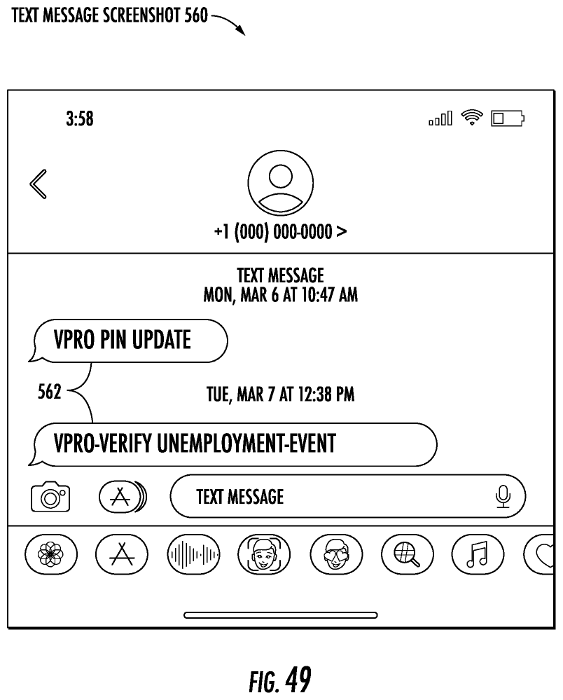

Referring now to FIG. 49 is a text message screenshot 560 of an example of text messages 562 received by an unemployed employee 570 being verified using VOE/VOI system 500 shown in FIG. 46, in accordance with an embodiment of the invention.

In one example, text message 562 may be “VPro PIN Update.” This is an example of a text message that may be automatically sent by VP application 110 at the completion of the PIN setup process that is performed by the unemployed employee 570.

In another example, text message 562 may be “VPro-Verify Unemployment-Event.” This is an example of a text message that may be automatically sent by VP application 110 at the completion of an unemployment verification request process that is performed by the verifier 572.

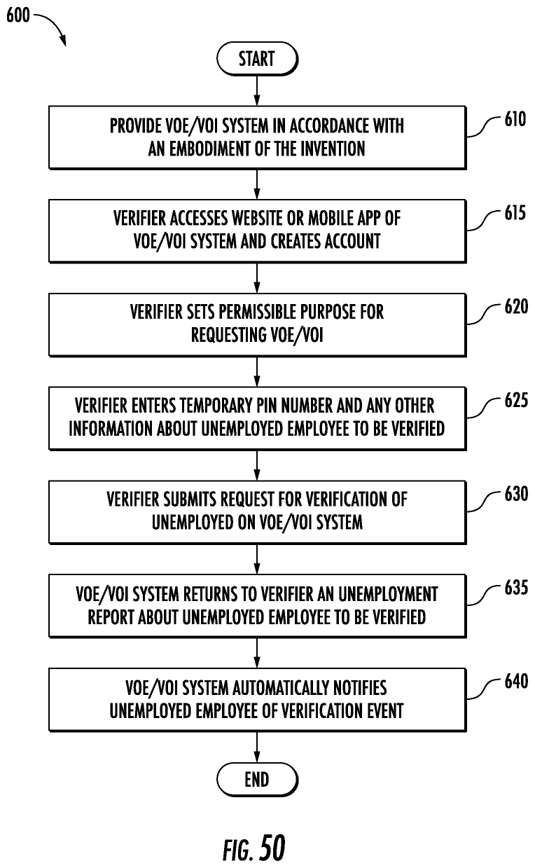

Referring now to FIG. 50 is a flow diagram of an example method 600 of a verifier 572 using the VOE/VOI system 500 shown in FIG. 46 with respect to notifications about unemployment claims and/or benefits, in accordance with an embodiment of the invention.

In advance of using method 600, the verifier 572 will have acquired the necessary information about the unemployed employee 570 who is the subject of the verification. For example, the verifier 572 will have acquired the name of the unemployed employee 570, the social security number of the unemployed employee 570, and the temporary PIN number of the unemployed employee 570. Further, the verifier 572 may use VP web portal 512 of VOE/VOI system 500 for performing the steps of method 600. Method 600 may include, but is not limited to, the following steps.

At a step 610, a VOE/VOI system is provided in accordance with an embodiment of the invention. For example, VOE/VOI system 500 including VP application 110 and data store 130 running on application server 145 as described above in FIG. 46 through FIG. 49 may be provided.

At a step 615, the verifier accesses the website or mobile app of the VOE/VOI system and creates an account on VOE/VOI system. For example, a verifier 572 opens VP web portal 512 or VP mobile app 582 and creates an account on VOE/VOI system 500. In one example, verifier 572 uses a login screen of VP web portal 512 to create an account on VOE/VOI system 500.

At a step 620, the verifier sets the permissible purpose for requesting the VOE/VOI. For example, using a login screen, the verifier 572 may select the permissible purpose for requesting the VOE/VOI (see FIG. 6 and FIG. 7). Examples of permissible purposes (or verification purposes) may include credit grantors, collection agency, insurance, mortgage, employer, rental housing, rental other, court order, government agency, open bank account, unemployment insurance, and the like.

At a step 625, the verifier enters the temporary PIN number and any other information about the unemployed employee to be verified. For example, using VP web portal 512, the verifier 572 may enter the social security number of the unemployed employee 570 and the verification purpose (e.g., unemployment verification). Then, using VP web portal 512, the verifier 572 may enter the temporary PIN number of the unemployed employee 570.

At a step 630, the verifier submits the request for verification of unemployment on the VOE/VOI system. For example, by selecting “Get Verification of Unemployment” on VP web portal 512, the verifier 572 may submit the request for “Verification of Unemployment” using VOE/VOI system 500.

At a step 635, the VOE/VOI system returns to the verifier the verification of unemployment report about the unemployed employee to be verified. For example, VP application 110 returns to the verifier 572 the verification of unemployment report about the unemployed employee 570 to be verified.

At a step 640, the VOE/VOI system automatically notifies the unemployed employee of the verification event. In one example, a text message may be automatically sent to the unemployed employee 570 by VP notification module 114 of VP application 110 upon receipt of the verification request. For example, FIG. 49 shows the “VPro-Verify Unemployment-Event” text message 562 that may be sent to the mobile phone of the unemployed employee 570. In another example, VP notification module 114 of VP application 110 automatically notifies the unemployed employee 570 of the verification event via a pop-up of VP mobile app 582 and/or VP desktop application 584. Further, step 640 of method 600 is not limited to text message notifications only. Other types of notifications are possible, such as, but not limited to, email and recorded phone calls.

In operation, a verifier 572, such as a government employment agency 550 and/or an unemployment insurance company 552 sees an unemployment insurance from a certain state with regard to a certain unemployed employee 570. Then, using VOE/VOI system 500 and method 600, a text message or popup may be sent to the phone of the unemployed employee 570 asking them whether they have submitted an unemployment claim. Then, the unemployed employee 570 may respond with either a YES or a NO. In this way the verifier 572 may determine whether the unemployment claim is legitimate or fraudulent.

In summary and referring now again to FIG. 46 through FIG. 50, VOE/VOI system 500 and method 600 may be used to facilitate employee information and/or notifications including VOE, VOI, and/or verification of unemployment claims and/or benefits. Accordingly, VOE/VOI system 500 and method 600 may be useful for helping to detect and prevent fraud in the unemployment benefits system.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the disclosure will be apparent to the skilled person without departing from the scope and spirit of the disclosure. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A verification system comprising:
a. a server, the server including a verification application, a controller, operating memory, and a communications interface, wherein the server is accessible via a network;
b. a data store in communication with the server;
c. one or more data sources, wherein the one or more data sources are accessible to the verification application via the network; and
d, wherein the controller is configured to execute stored program instructions, comprising:
i. providing access to a user of the verification system;
ii. receiving a submission for a verification request by a verifier;
iii. processing the verification request; and
iv. automatically sending a notification to a verifyee that is the subject of the verification request that the verification request has been requested.

2. The system of claim 1, wherein the verification system is for verifying one or more of employment, income, and/or unemployment claims and/or benefits of the verifyee.

3. The system of claim 1, wherein receiving a submission for a verification request comprises receiving a permitted purpose for the verification request; and receiving identifying information related to the verifyee.

4. The system of claim 3, wherein the identifying information related to the verifyee comprises a temporary PIN.

5. The system of claim 4, wherein the temporary PIN is set by the verifyee and has a defined expiration date, and wherein the temporary PIN is provided to the verifier by the verifyee.

6. The system of claim 1, wherein the controller is configured to execute stored program instructions, further comprising, upon processing the verification request, automatically generating a verification report about the verifyee.

7. The system of claim 6, wherein the verification report comprises information related to one or more of employment, income, and/or unemployment claims and/or benefits of the verifyee.

8. The system of claim 1, wherein the notification comprises a text message and/or a pop-up notification.

9. The system of claim 1, wherein the data store comprises employer records, wherein the employer records include employee data.

10. A method of using a verification system, the method comprising:
a. providing a verification system comprising:
i. a server, the server including a verification application, a controller, operating memory, and a communications interface, wherein the server is accessible via a network;
ii. a data store in communication with the server;
iii. one or more data sources, wherein the one or more data sources are accessible to the verification application via the network; and
iv, wherein the controller is configured to execute stored program instructions, comprising:
A. providing access to a user of the verification system;
B. receiving a submission for a verification request by a verifier;
C. processing the verification request;
D. automatically generating a verification report about a verifyee that is the subject of the verification request; and
E. automatically sending a notification to the verifyee that the verification request has been requested.
b. accessing the verification application;
c. selecting a permitted purpose for submitting the verification request;
d. inputting identifying information related to the verifyee;
e. submitting the verification request; and
f. receiving a verification report about the verifyee.

11. The method of claim 10, wherein the verification system is for verifying one or more of employment, income, and/or unemployment claims and/or benefits of the verifyee.

12. The method of claim 10, wherein the identifying information related to the verifyee comprises a temporary PIN.

13. The method of claim 12, wherein the temporary PIN is set by the verifyee and has a defined expiration date, and wherein the temporary PIN is provided to the verifier by the verifyee.

14. The method of claim 10, wherein the verification report comprises information related to one or more of employment, income, and/or unemployment claims and/or benefits of the verifyee.

15. The method of claim 10, wherein the data store comprises employer records, wherein the employer records include employee data.

16. The method of claim 10, further comprising automatically sending a notification to the verifyee that the verification request has been requested.

17. The method of claim 16, wherein the notification comprises a text message and/or a pop-up notification.

18. A verification system comprising:
a. a server, the server including a verification application, a controller, operating memory, and a communications interface, wherein the server is accessible via a network;
b. a data store in communication with the server;
c. one or more data sources, wherein the one or more data sources are accessible to the verification application via the network; and
d, wherein the controller is configured to execute stored program instructions, comprising:
i. providing access to a verifyee user of the verification system;
ii. receiving and storing verifyee user information; and
iii. enabling one or more types of verifications allowable for a verification request.

19. The system of claim 18, wherein the verifyee user information comprises a master PIN and a temporary PIN.

20. The system of claim 19, wherein the temporary PIN is set by the verifyee user and has a defined expiration date.

21. The system of claim 19, wherein the master PIN is assigned by a past or present employer of the verifyee user.

22. The system of claim 18, wherein the verification system is for verifying one or more of employment, income, and/or unemployment claims and/or benefits of the verifyee user.

23. The system of claim 19, wherein the controller is configured to execute stored program instructions, further comprising, upon the verifyee user setting or updating the temporary PIN, automatically generating and sending a notification to the verifyee user that a temporary PIN event has occurred; and upon a verification request being submitted regarding the verifyee user, automatically generating and sending a notification to the verifyee user that a verification event has occurred.

24. The system of claim 23, wherein the notification comprises a text message and/or a pop-up notification.

25. The system of claim 18, wherein the data store comprises employer records, wherein the employer records include employee data.

26. A method of using a verification system comprising:
a. providing a verification system comprising:
i. a server, the server including a verification application, a controller, operating memory, and a communications interface, wherein the server is accessible via a network;
ii. a data store in communication with the server;
iii. one or more data sources, wherein the one or more data sources are accessible to the verification application via the network; and
iv, wherein the controller is configured to execute stored program instructions, comprising:
A. providing access to a verifyee user of the verification system;
B. receiving and storing verifyee user information; and
C. enabling one or more types of verifications allowable for a verification request;
b. accessing the verification application;
c. inputting verifyee user information, including setting a temporary PIN, wherein the temporary PIN is set by the verifyee user and has a defined expiration date;
d. enabling one or more types of verifications allowable for a verification request; and
e. providing the temporary PIN to a verifier.

27. The method of claim 26, wherein the verifyee user information further comprises a master PIN, wherein the master PIN is assigned by a past or present employer of the verifyee user.

28. The method of claim 26, wherein the verification system is for verifying one or more of employment, income, and/or unemployment claims and/or benefits of the verifyee user.

29. The method of claim 26, wherein the controller is configured to execute stored program instructions, further comprising, upon the verifyee user setting or updating the temporary PIN, automatically generating and sending a notification to the verifyee user that a temporary PIN event has occurred; and upon a verification request being submitted regarding the verifyee user, automatically generating and sending a notification to the verifyee user that a verification event has occurred.

30. The method of claim 29, wherein the notification comprises a text message and/or a pop-up notification.
